(19) United States
(12) Patent Application Publication
(10) Pub. No.: US 2011/0102761 A1
(43) Pub. Date: May 5, 2011

(54) STAGE APPARATUS, EXPOSURE APPARATUS, AND DEVICE FABRICATING METHOD

(75) Inventor: Hiromitsu YOSHIMOTO, Saitama-shi (JP)

(73) Assignee: NIKON CORPORATION, TOKYO (JP)

(21) Appl. No.: 12/887,715

(22) Filed: Sep. 22, 2010

Related U.S. Application Data
(60) Provisional application No. 61/272,470, filed on Sep. 28, 2009.

(51) Int. Cl. G03B 27/58; B23Q 1/64

(52) U.S. Cl. 355/72; 355/77; 269/56

(57) ABSTRACT

A stage apparatus comprises: a measuring apparatus that radiates a measurement beam to a measurement surface, which is formed on a surface on an side opposite a holding surface whereon an object of an holding member is held, and measures the position of the holding member in a direction corresponding to six degrees of freedom by receiving a reflected beam of the measurement beam reflected from the measurement surface; and a control apparatus that, based on tilt information of the positional information of the holding member, corrects information selected from the group consisting of the first direction positional information and the second direction positional information of the holding member.

### CROSS-REFERENCE TO RELATED APPLICATION

This application is a non-provisional application claiming priority to and the benefit of U.S. provisional application No. 61/272,470, filed Sep. 28, 2009. The entire contents of which are incorporated herein by reference.

### BACKGROUND

The present invention relates to a stage apparatus, an exposure apparatus, and a device fabricating method.

Conventionally, lithographic processes that fabricate electronic devices (i.e., microdevices), such as semiconductor devices (i.e., integrated circuits and the like) and liquid crystal display devices, principally use step-and-repeat type projection exposure apparatuses (i.e., so-called steppers), step-and-scan type projection exposure apparatuses (i.e., so-called scanning steppers or scanners), or the like.

In these types of exposure apparatuses, the position of a wafer stage that holds a substrate, such as a glass plate or a wafer whereon a pattern to be transferred is formed (hereinbelow, generically called a “wafer”), and that moves two dimensionally is generally measured using laser interferometers. However, the increased fineness of patterns that attends the higher levels of integration of semiconductor devices in recent years has produced a demand for higher precision control of the position of the wafer stage; therefore, ignoring short-term fluctuations in measurement values owing to air turbulence generated by the effects of a temperature gradient and/or by changes in the temperature of the atmosphere along the paths of the beams of the laser interferometers is no longer possible.

To correct such problems, various inventions have been proposed (e.g., refer to U.S. Patent Application Publication No. 200810088843) related to exposure apparatuses that use an encoder, which has a measurement resolving power on the same order as or better than that of laser interferometers, as an apparatus for measuring the position of the wafer stage. However, in the immersion exposure apparatus disclosed in U.S. Patent Application Publication No. 2008/0088843 and the like, there is a risk that the wafer stage (i.e., a grating provided to an upper surface of the wafer stage) will deform because of the effects of heat of vaporization and the like when a liquid evaporates, and this problem has yet to be corrected.

To correct these problems, for example, a fifth embodiment in U.S. Patent Application Publication No. 2008/0094594 discloses an exposure apparatus that comprises an encoder system wherein a grating is provided to the upper surface of a wafer stage, which comprises a light transmitting member, a measurement beam emerges from an encoder main body disposed below the wafer stage, and the measurement beam is caused to impinge the wafer stage, after which it is radiated to the grating; furthermore, the displacement of the wafer stage in the grating's directions of periodicity is measured by receiving the diffracted light generated by the grating. In this apparatus, the grating is covered by a cover glass and therefore tends not to be affected by heat of vaporization and the like, which enables the grating to measure the position of the wafer stage with high accuracy.

Nevertheless, if the position of a fine motion stage is measured using a stage apparatus with a so-called coarse motion structure, which combines a coarse motion stage that moves on a base plate and a fine motion stage that holds the wafer and is disposed on and moves relative to the coarse motion stage, arranging the encoder main body used in the exposure apparatus according to the fifth embodiment of U.S. Patent Application Publication No. 2008/0094594 is difficult because the coarse motion stage is disposed between the fine motion stage and the base plate.

In addition, when an exposure and the like is performed on the wafer, which is disposed on the wafer stage, it is preferable to measure the position of the wafer stage within a two dimensional plane that includes the exposure point of the front surface of the wafer; however, if the wafer stage is tilted with respect to that two dimensional plane, then the measurement value of the encoder that measures the position of the wafer stage from, for example, below will contain error owing to, for example, the difference in the height of the front surface of the wafer and the height of the installation surface of the grating.

### SUMMARY

A stage apparatus according to an aspect of the present invention comprises: a first moving body, which comprises a guide member that extends in a first direction, that moves in a second direction, which is substantially orthogonal to the first direction; two second moving bodies, which are provided along the guide member such that they are independently moveable in the first direction, that move in the second direction together with the guide member by the movement of the first moving body; a holding member, which is detachably supported by the two second moving bodies, that is capable of moving with six degrees of freedom with respect to the two second moving bodies while holding an object; a measuring apparatus that radiates a measurement beam to a measurement surface, which is formed on a surface on the side opposite a holding surface whereon the object of the holding member is held, and measures the position of the holding member in a direction corresponding to six degrees of freedom by receiving the reflected beam of the measurement beam reflected from the measurement surface; and a control apparatus that, based on tilt information of the positional information of the holding member, corrects information selected from the group consisting of the first direction positional information and the second direction positional information of the holding member.

An exposure apparatus according to anther aspect of the present invention is an apparatus that forms a pattern on an object by radiating an energy beam and comprises: a patterning apparatus, which radiates the energy beam to the object; and the previously mentioned stage apparatus, wherein the object irradiated by the energy beam is held by the moving body.

A device fabricating method according to an aspect of the present invention comprises the steps of: exposing a substrate, which serves as the object, using the exposure apparatus of the present invention; and developing the exposed substrate.

According to aspects of the present invention, a holding member can be driven with high accuracy without being affected by measurement error, which is included in information related to a position measured by a measurement system, arising from the tilt of the holding member.

### BRIEF DESCRIPTION OF THE DRAWINGS

FIG. 1 schematically shows the configuration of an exposure apparatus of one embodiment.

FIG. 2 is a schematic oblique view of a stage apparatus provided by the exposure apparatus shown in FIG. 1.

FIG. 3 is an exploded oblique view of the stage apparatus shown in FIG. 2.

FIG. 4A is a side view, viewed from the −Y direction, that shows the stage apparatus provided by the exposure apparatus shown in FIG. 1.

FIG. 4B is a plan view that shows the stage apparatus.

FIG. 5 is a block diagram that shows the configuration of a control system of the exposure apparatus in shown FIG. 1.

FIG. 6 is a plan view that shows the arrangement of magnet units and a coil unit that constitute a fine motion stage drive system.

FIG. 7A is a view for explaining the operation performed when a fine motion stage is rotated around the Z axis with respect to coarse motion stages.

FIG. 7B is a view for explaining the operation performed when the fine motion stage is rotated around the Y axis with respect to the coarse motion stages.

FIG. 7C is a view for explaining the operation performed when the fine motion stage is rotated around the X axis with respect to the coarse motion stages.

FIG. 8 is a view for explaining the operation performed when a center part of the fine motion stage is flexed in the +Z direction.

FIG. 9A is an oblique view that shows a tip part of a measuring arm.

FIG. 9B is a plan view, viewed from the +Z direction, of the upper surface of the tip part of the measuring arm.

FIG. 10A is a block diagram of an X head.

FIG. 10B is for explaining the arrangement of the X head and Y heads inside the measuring arm.

FIG. 11 is a graph that shows the measurement error of an encoder against a Z position of the fine motion stage and an amount of pitching θx.

FIG. 12A is for explaining a method of driving a wafer during a scanning exposure.

FIG. 12B is for explaining the method of driving the wafer during stepping.

FIG. 13 shows the arrangement of a grating according to a modified example.

FIG. 14 is a schematic oblique view of a stage apparatus that has two stage units.

FIG. 15 is a flow chart that depicts one example of a process of fabricating a microdevice.

FIG. 16 depicts one example of the detailed process of wafer processing step described in FIG. 15.

### DESCRIPTION OF EMBODIMENTS

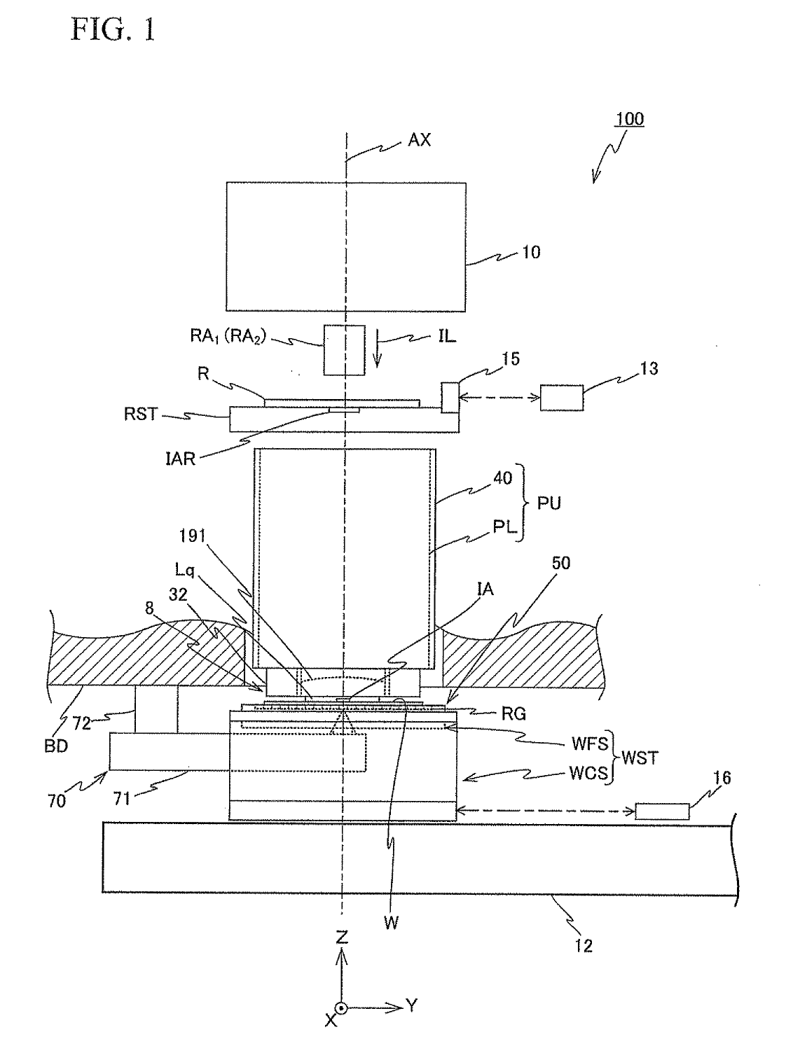

The following text explains a stage apparatus, an exposure apparatus, and a device fabricating method according to an embodiment of the present invention, referencing FIG. 1 through FIG. 16.

FIG. 1 schematically shows the configuration of an exposure apparatus 100 according to one embodiment. The exposure apparatus 100 is a step-and-scan-type projection exposure apparatus, namely, a so-called scanner. In the present embodiment as discussed below, a projection optical system PL is provided; furthermore, in the explanation below, the directions parallel to an optical axis AX of the projection optical system PL are the Z axial directions, the directions within a plane that is orthogonal thereto and wherein a reticle and a wafer are scanned relative to one another are the Y axial directions, the directions that are orthogonal to the Z axis and the Y axis are the X axial directions, and the rotational (i.e., tilt) directions around the X axis, the Y axis, and the Z axis are the θx, the θy, and the θz directions, respectively.

The exposure apparatus 100 comprises an illumination system 10, a reticle stage RST, a projection unit PU, a local liquid immersion apparatus 8, a stage apparatus 50 that has a fine motion stage WFS, and a control system that controls these elements. In FIG. 1, a wafer W is mounted on the fine motion stage WFS.

As disclosed in, for example, U.S. Patent Application Publication No. 2003/0025890, the illumination system 10 comprises an illumination optical system that comprises: a light source; a luminous flux intensity uniformizing optical system, which includes an optical integrator and the like; and a reticle blind (none of which are shown). The illumination system 10 illuminates, with illumination light IL (i.e., exposure light) at a substantially uniform luminous flux intensity, a slit shaped illumination area IAR, which is defined by a reticle blind (also called a masking system), on a reticle R. Here, as one example, ArF excimer laser light (with a wavelength of 193 nm) is used as the illumination light IL.

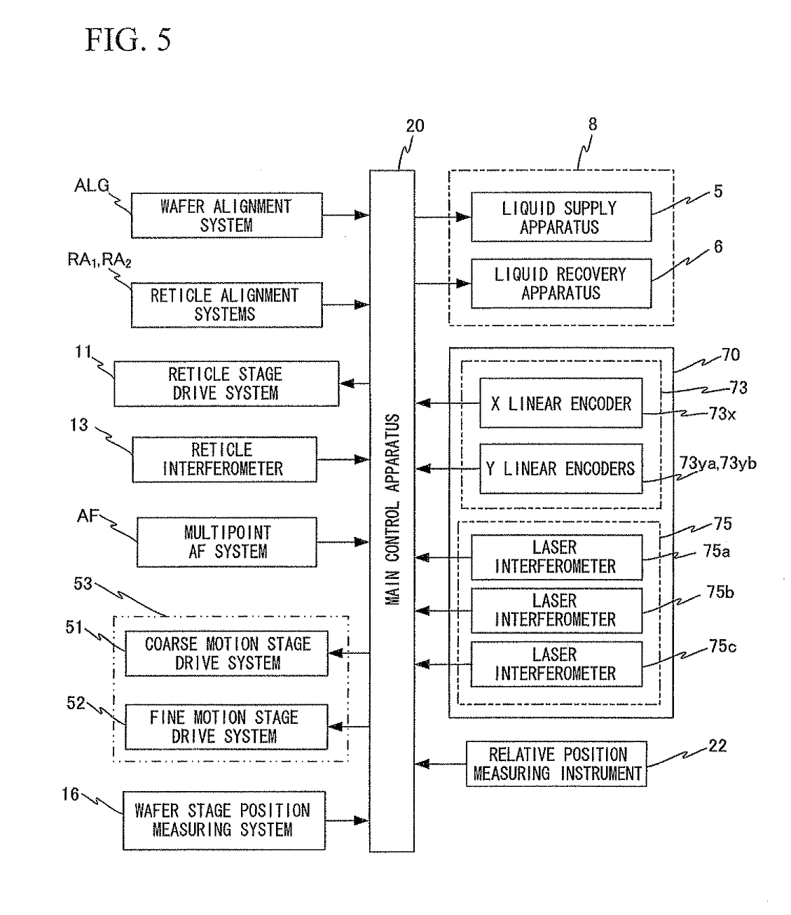

The reticle R, whose patterned surface (i.e., in FIG. 1, a lower surface) has a circuit pattern and the like formed thereon, is fixed onto the reticle stage RST by, for example, vacuum chucking. A reticle stage drive system 11 (not shown in FIG. 1; refer to FIG. 5) that comprises, for example, linear motors is capable of driving the reticle stage RST finely within an XY plane and at a prescribed scanning speed in scanning directions (i.e., in the Y axial directions, which are the lateral directions within the paper plane of FIG. 1).

A reticle laser interferometer 13 (hereinbelow, called a “reticle interferometer”) continuously detects, with a resolving power of, for example, approximately 0.25 nm, the position (including rotation in the θz directions) of the reticle stage RST within the XY plane via movable mirrors 15, which are fixed to the reticle stage RST. Measurement values of the reticle interferometer 13 are sent to a main control apparatus 20 (not shown in FIG. 1; refer to FIG. 5).

The projection unit PU is disposed below the reticle stage RST in FIG. 1. The projection unit PU comprises a lens barrel 40 and the projection optical system PL, which comprises a plurality of optical elements that are held inside the lens barrel 40. A dioptric optical system that is, for example, telecentric on both sides and has a prescribed projection magnification (e.g., ¼×, 115×, or ⅛×) is used as the projection optical system PL. Consequently, when the illumination light IL that emerges from the illumination system 10 illuminates the illumination area IAR on the reticle R, the illumination light IL that passes through the reticle R, whose patterned surface is disposed substantially coincident with a first plane (i.e., the object plane) of the projection optical system PL, travels through the projection optical system PL (i.e., the projection unit PU) and forms a reduced image of a circuit pattern of the reticle R that lies within that illumination area IAR (i.e., a reduced image of part of the circuit pattern) on the wafer W, which is disposed on a second plane side (i.e., the image plane side) of the projection optical system PL and whose front surface is coated with a resist (i.e., a sensitive agent), in an area IA (hereinbelow, also called an “exposure area”) that is conjugate with the illumination area IAR. Furthermore, by synchronously scanning the reticle stage RST and the fine motion stage WFS, the reticle R is moved relative to the illumination area IAR (i.e., the illumination light IL) in one of the scanning directions (i.e., one of the Y axial directions) and the wafer W is moved relative to the exposure area IA (i.e., the illumination light IL) in the other scanning direction (i.e., the other Y axial direction); thereby, a single shot region (i.e., block area) on the wafer W undergoes a scanning exposure and the pattern of the reticle R is transferred to that shot region. Namely, in the present embodiment, the pattern of the reticle R is created on the wafer W by the illumination system 10 and the projection optical system PL, and that pattern is formed on the wafer W by exposing a sensitive layer (i.e., a resist layer) on the wafer W with the illumination light IL.

The local liquid immersion apparatus 8 comprises a liquid supply apparatus 5 and a liquid recovery apparatus 6 (both of which are not shown in FIG. 1; refer to FIG. 5) as well as a nozzle unit 32. As shown in FIG. 1, the nozzle unit 32 is suspended from a main frame BD, which supports the projection unit PU and the like, via a support member (not shown) such that the nozzle unit 32 surrounds a lower end part of the lens barrel 40 that holds the optical element—of the optical elements that constitute the projection optical system PL—that is most on the image plane side (i.e., the wafer W side), here, a lens 191 (hereinbelow, also called a “tip lens”). In the present embodiment, the main control apparatus 20 controls both the liquid supply apparatus 5 (refer to FIG. 5), which via the nozzle unit 32 supplies a liquid to the space between the tip lens 191 and the wafer W, and the liquid recovery apparatus 6 (refer to FIG. 5), which via the nozzle unit 32 recovers the liquid from the space between the tip lens 191 and the wafer W. At this time, the main control apparatus 20 controls the liquid supply apparatus 5 and the liquid recovery apparatus 6 such that the amount of the liquid supplied and the amount of the liquid recovered are always equal. Accordingly, a fixed amount of a liquid Lq (refer to FIG. 1) is continuously being replaced and held between the tip lens 191 and the wafer W. In the present embodiment, it is understood that pure water, through which ArF excimer laser light (i.e., light with a wavelength of 193 nm) transmits, is used as the abovementioned liquid.

As shown in FIG. 1, the stage apparatus 50 comprises: a base plate 12, which is supported substantially horizontally by a vibration isolating mechanism (not illustrated) on a floor surface; a wafer stage WST, which holds the wafer W and moves on the base plate 12; a wafer stage drive system 53 (refer to FIG. 5), which drives the wafer stage WST; and various measurement systems (16, 70) (refer to FIG. 5).

The base plate 12 comprises a member, whose outer shape is shaped as a flat plate and whose upper surface is finished to an extremely high degree of flatness, and serves as a guide surface when the wafer stage WST is moved.

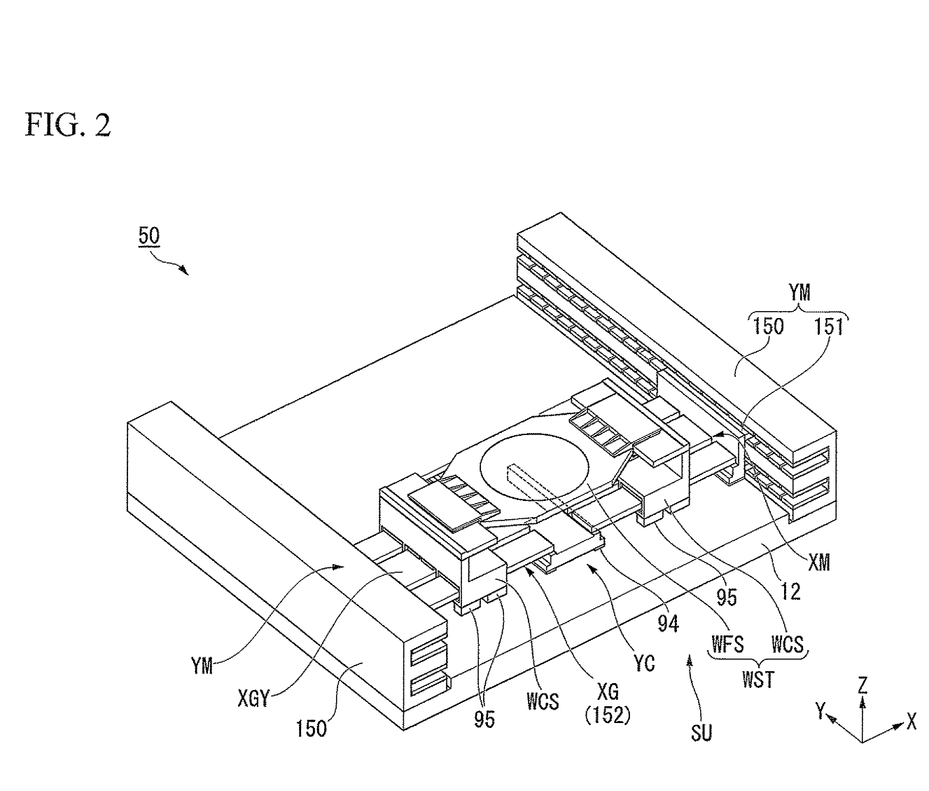

As shown in FIG. 2, the stage apparatus 50 comprises: a Y coarse motion stage YC (i.e., a first moving body), which moves by the drive of Y motors YM; two X coarse motion stages WCS (i.e., second moving bodies), which move independently by the drive of X motors XM; and the fine motion stage WFS, which holds the wafer W and is moveably supported by the X coarse motion stages WCS. The Y coarse motion stage YC and the X coarse motion stages WCS constitute a stage unit SU. In addition, the Y motors YM and the X motors XM collectively constitute a coarse motion stage drive system 51 (refer to FIG. 5).

The pair of X coarse motion stages WCS and the fine motion stage WFS constitute the wafer stage WST discussed above. The fine motion stage WFS is driven by a fine motion stage drive system 52 (refer to FIG. 5) in the X, Y, Z, θx, θy, and θz directions, which correspond to six degrees of freedom, with respect to the X coarse motion stages WCS. In the present embodiment, the coarse motion stage drive system 51 and the fine motion stage drive system 52 constitute the wafer stage drive system 53.

A wafer stage position measuring system 16 (not shown in FIG. 2; refer to FIG. 1 and FIG. 5) measures the position within the XY plane (including the rotation in the θz directions) of the wafer stage WST (i.e., the coarse motion stages WCS). In addition, the fine motion stage position measuring system 70 measures the position of the fine motion stage WFS, which the coarse motion stages WCS support, in the directions corresponding to six degrees of freedom (i.e., the X, Y, Z, θx, θy, and θz directions). The measurement results of the wafer stage position measuring system 16 and the fine motion stage position measuring system 70 are supplied to the main control apparatus 20 (refer to FIG. 5), which uses these measurement results to control the positions of the X coarse motion stages WCS and the fine motion stage WFS.

When the fine motion stage WFS is supported by the X coarse motion stages WCS, a relative position measuring instrument 22 (refer to FIG. 5), which is provided between the coarse motion stages WCS and the fine motion stage WFS, can measure the relative position of the fine motion stage WFS and the coarse motion stages WCS in the X, Y, and θz directions, which correspond to three degrees of freedom.

It is possible to use as the relative position measuring instrument 22, for example, an encoder wherein a grating provided to the fine motion stage WFS serves as a measurement target, the X coarse motion stages WCS are each provided with at least two heads, and the position of the fine motion stage WFS in the X axial directions, the Y axial directions, and the θz directions is measured based on the outputs of these heads. The measurement results of the relative position measuring instrument 22 are supplied to the main control apparatus 20 (refer to FIG. 5).

The configuration and the like of the wafer stage position measuring system 16, the fine motion stage position measuring system 70, and each part of the stage apparatus 50 will be discussed in detail later.

In the exposure apparatus 100, a wafer alignment system ALG (not shown in FIG. 1; refer to FIG. 5) is disposed at a position at which it is spaced apart by a prescribed distance from the center of the projection unit PU on the +Y side thereof. For example, an image processing type field image alignment (FIA) system is used as the alignment system ALG When a wafer alignment (e.g., an enhanced global alignment (EGA)) is performed, the main control apparatus 20 uses the wafer alignment system ALG to detect a second fiducial mark, which is formed in a measuring plate on the fine motion stage WFS (discussed later), or an alignment mark on the wafer W. The captured image signal output by the wafer alignment system ALG is supplied to the main control apparatus 20 via a signal processing system (not shown). During the alignment of the target mark, the main control apparatus 20 calculates the X and Y coordinates in a coordinate system based on the result of the detection of the wafer alignment system ALG and the position information of the fine motion stage WFS (i.e., the wafer W) during the detection.

In addition, in the exposure apparatus 100 of the present embodiment, an oblique incidence type multipoint focus position detection system AF (hereinbelow, abbreviated as “multipoint AF system”; not shown in FIG. 1; refer to FIG. 5), which is configured identically to the one disclosed in, for example, U.S. Pat. No. 5,448,332, is provided in the vicinity of the projection unit PU. The detection signal of the multipoint AF system AF is supplied to the main control apparatus 20 (refer to FIG. 5) via an AF signal processing system (not shown). The main control apparatus 20 detects, based on the detection signal output by the multipoint AF system AF, the position of the front surface of the wafer W in the Z axial directions at each detection point of a plurality of detection points of the multipoint AF system AF (i.e., the surface position information) and, based on the results of that detection, performs a so-called focus and leveling control on the wafer W during the scanning exposure. Furthermore, the multipoint AF system may be provided in the vicinity of the wafer alignment system ALG, the surface position information (i.e., nonuniformity information) of the front surface of the wafer W during wafer alignment (EGA) may be acquired beforehand, and the so-called focus and leveling control may be performed on the wafer W during an exposure using the surface position information and a measurement value of a laser interferometer system 75 (refer to FIG. 5), which constitutes part of the fine motion stage position measuring system 70 (discussed below).

In addition, a pair of image processing type reticle alignment systems RA₁, RA₂ (in FIG. 1, the reticle alignment system RA₂ is hidden on the paper plane far side of the reticle alignment system RA₁), each of which uses light (in the present embodiment, the illumination light IL) of the exposure wavelength as the illumination light for alignment, is disposed above the reticle stage RST, as disclosed in detail in, for example, U.S. Pat. No. 5,646,413. The detection signals of the reticle alignment systems RA₁, RA₂ are supplied to the main control apparatus 20 (refer to FIG. 5) via a signal processing system (not shown).

FIG. 5 shows the principal components of the control system of the exposure apparatus 100. The heart of the control system is the main control apparatus 20. The main control apparatus 20 is, for example, a workstation (or a microcomputer) that supervisorally controls each constituent part of the exposure apparatus 100 such as the local liquid immersion apparatus 8, the coarse motion stage drive system 51, and the fine motion stage drive system 52, which are all discussed above.

In addition, in the exposure apparatus 100 of the present embodiment, a pair of image processing type reticle alignment systems RA₁, RA₂ (in FIG. 1, the reticle alignment system RA₂ is hidden on the paper plane far side of the reticle alignment system RA₁), each of which comprises an image capturing device such as a CCD and uses light (in the present embodiment, the illumination light IL) of the exposure wavelength as the illumination light for alignment, is disposed above the reticle stage RST, as disclosed in detail in, for example, U.S. Pat. No. 5,646,413. In a state wherein a measuring plate (discussed below) is positioned on the fine motion stage WFS directly below the projection optical system PL, the main control apparatus 20 uses the pair of reticle alignment systems RA₁, RA₂ to detect, through the projection optical system PL, a pair of first fiducial marks on the measuring plate corresponding to a projected image of a pair of reticle alignment marks (not illustrated) formed on the reticle R; thereby, the positional relationship between the center of the projection area of the pattern of the reticle R formed by the projection optical system PL and the reference positions on the measuring plate, namely, the centers of the two first fiducial marks, is detected. The detection signals of the reticle alignment systems RA₁, RA₂ are supplied to the main control apparatus 20 (refer to FIG. 5) via a signal processing system (not shown).

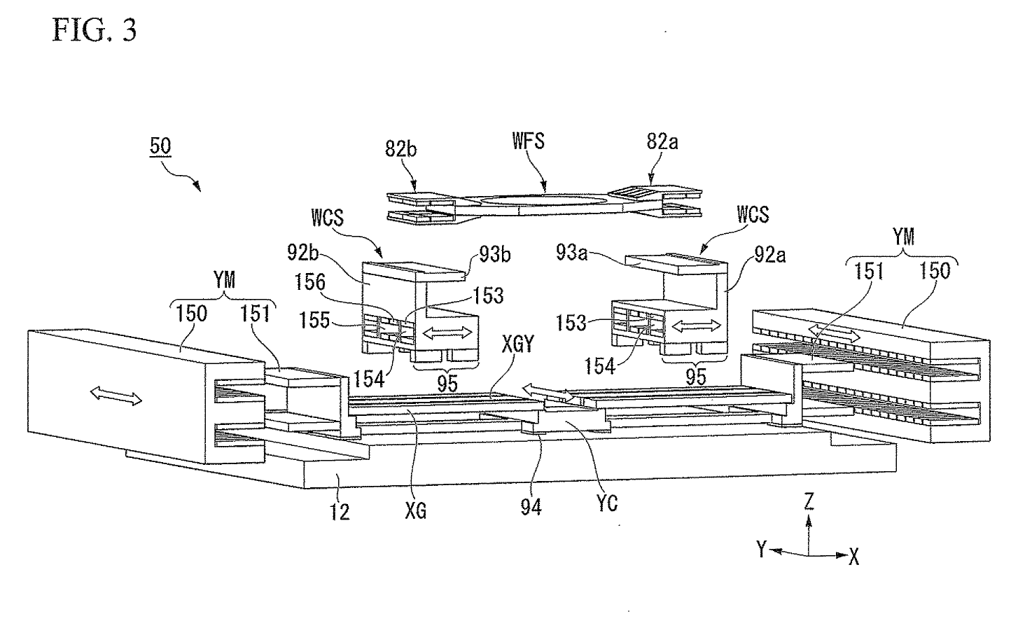

Continuing, the configuration and the like of each part of the stage apparatus 50 will now be discussed in detail, referencing FIG. 2 and FIG. 3.

The Y motors YM comprise stators 150, which are provided on both side ends of the base plate 12 in the X directions such that they extend in the Y directions, and sliders 151, which are provided on both ends of the Y coarse motion stage YC in the X directions. The stators 150 comprise permanent magnets, which are arrayed in the Y directions, and the sliders 151 comprise coils, which are arrayed in the Y directions. Namely, the Y motors YM are moving coil type linear motors that drive both the wafer stage WST and the Y coarse motion stage YC in the Y directions. Furthermore, while the above text explains an exemplary case of moving coil type linear motors, the linear motors may be moving magnet type linear motors.

In addition, aerostatic bearings (not shown), for example, air bearings, which are provided to the lower surfaces of the stators 150, levitationally support the stators 150 above the base plate 12 with a prescribed clearance. Thereby, the reaction force generated by the movement of the wafer stage WST, the Y coarse motion stage YC, and the like in either one of the Y directions moves the stators 150, which serve as Y countermasses in the Y directions, in the other Y direction and is thereby offset by the law of conservation of momentum.

The Y coarse motion stage YC comprises X guides XG (i.e., guide members), which are provided between the sliders 151, 151 and extend in the X directions, and is levitationally supported above the base plate 12 by a plurality of noncontact bearings, for example, air bearings 94, that is provided to a bottom surface of the Y coarse motion stage YC.

The X guides XG are provided with stators 152, which constitute the X motor XM. As shown in FIG. 3, sliders 153 of the X motor XM are provided with through holes 154, wherethrough the X guides XG are inserted, that pass through the X coarse motion stages WCS in the X directions.

The two X coarse motion stages WCS are each levitationally supported above the base plate 12 by a plurality of noncontact bearings, for example, air bearings 95, provided to the bottom surfaces of the X coarse motion stages WCS and move in the X directions independently of one another along the X guides XG by the drive of the X motors XM. The Y coarse motion stage YC is provided with, in addition to the X guides XG, X guides XGY whereto the stators of the Y linear motors that drive the X coarse motion stages WCS in the Y directions are provided. Furthermore, in each of the X coarse motion stages WCS, a slider 156 of the Y linear motor is provided in a through hole 155 (refer to FIG. 3), which passes through the X coarse motion stages WCS in the X directions. Furthermore, a configuration may be adopted wherein the X coarse motion stages WCS are supported in the Y directions by providing air bearings instead of providing the Y linear motors.

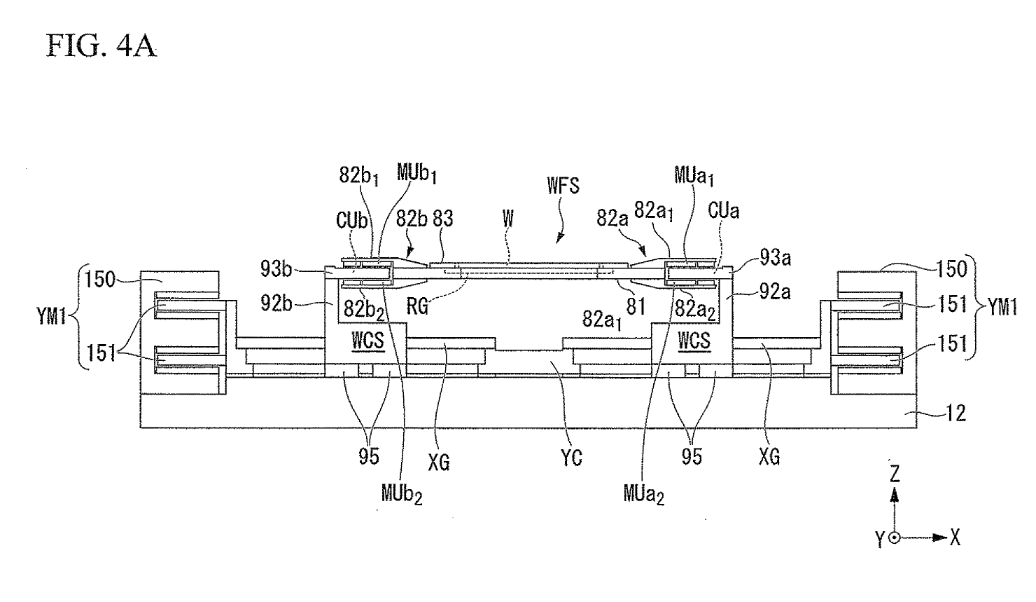

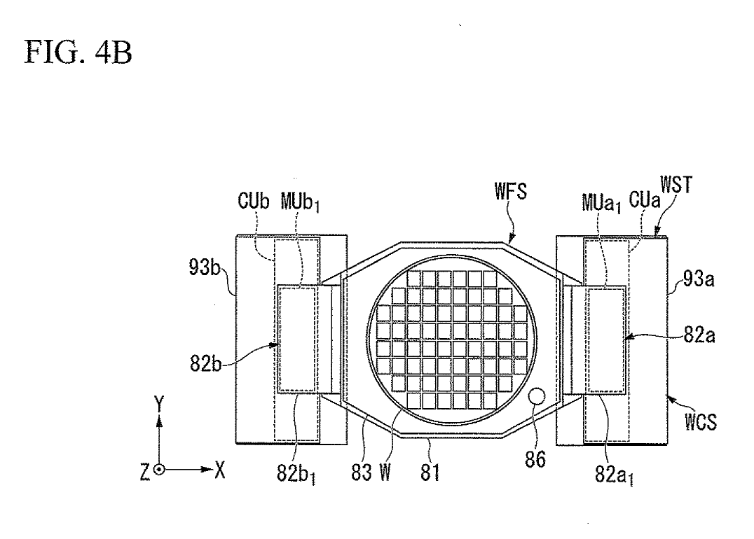

FIG. 4(A) is a side view, viewed from the −Y direction, of the stage apparatus 50, and FIG. 4(B) is a plan view of the stage apparatus 50. As shown in FIG. 4(A) and FIG. 4(B), a pair of sidewall parts 92a, 92b and a pair of stator parts 93a, 93b, which are fixed to the upper surfaces of the sidewall parts 92a, 92b, are provided to the outer side end parts in the X directions of the X coarse motion stages WCS. As a whole, each of the coarse motion stages WCS has a box shape with a small height and that is open at the center part of the upper surface in the X axial directions and both side surfaces in the Y axial directions. Namely, a space is formed in each of the coarse motion stages WCS such that the space passes through the inner part of the coarse motion stages WCS in the Y axial directions.

Each of the stator parts 93a, 93b is a member with an outer plate shape; furthermore, the stator parts 93a, 93b house coil units CUa, CUb, which are for driving the fine motion stage WFS. The main control apparatus 20 controls the size and direction of each electric current supplied to the coils that constitute the coil units CUa, CUb. The configuration of the coil units CUa, CUb will be discussed further below.

The +X side end part of the stator part 93a is fixed to the upper surface of the sidewall part 92a, and the −X side end part of the stator part 93b is fixed to the upper surface of the sidewall part 92b.

As shown in FIG. 4A and FIG. 4B, the fine motion stage WFS comprises a main body part 81, which consists of an octagonal plate shaped member whose longitudinal directions are oriented in the X axial directions in a plan view, and two slider parts 82a, 82b (slider part 82), which are fixed to one end part and the other end part of the main body part 81 in the longitudinal directions.

Because an encoder system measurement beam, which is discussed below, must be able to travel through the inner part of the main body part 81, the main body part 81 is formed from a transparent raw material wherethrough light can transmit. In addition, to reduce the effects of air turbulence on the measurement beam that passes through the inner part of the main body part 81, the main body part 81 is formed as a solid block (i.e., its interior has no space). Furthermore, the transparent raw material preferably has a low coefficient of thermal expansion; in the present embodiment, as one example, synthetic quartz (i.e., glass) is used. Furthermore, although the entire main body part 81 may be formed from the transparent material, a configuration may be adopted wherein only the portion wherethrough the measurement beam of the encoder system transmits is formed from the transparent raw material; furthermore, a configuration may be adopted wherein only the latter is formed as a solid.

A wafer holder (not shown), which holds the wafer W by vacuum chucking or the like, is provided at the center of the upper surface of the main body part 81 of the fine motion stage WFS. Furthermore, the wafer holder may be formed integrally with the fine motion stage WFS and may be fixed to the main body part 81 by bonding and the like or via, for example, an electrostatic chuck mechanism or a clamp mechanism.

Furthermore, as shown in FIG. 4A and FIG. 4B, a circular opening whose circumference is larger than the wafer W (i.e., the wafer holder) is formed in the center of the upper surface of the main body part 81 on the outer side of the wafer holder (i.e., the mounting area of the wafer W), and a plate 83 (i.e., a liquid repellent plate), whose octagonal outer shape (i.e., contour) corresponds to the main body part 81, is attached to the upper surface of the main body part 81. The front surface of the plate 83 is given liquid repellency treatment (i.e., a liquid repellent surface is formed) such that it is liquid repellent with respect to the liquid Lq. The plate 83 is fixed to the upper surface of the main body part 81 such that the entire front surface (or part of the front surface) of the plate 83 is coplanar with the front surface of the wafer W. In addition, as shown in FIG. 4B, a circular opening is formed in one end part of the plate 83 and a measuring plate 86 is embedded in that opening in the state wherein the front surface of the measuring plate 86 is substantially coplanar with the front surface of the plate 83, namely, the front surface of the wafer W. At least a pair of the first fiducial marks discussed above and the second fiducial mark, which is detected by the wafer alignment system ALG, are formed in the front surface of the measuring plate 86 (note that none of the first and second fiducial marks are shown).

As shown in FIG. 4A, a two-dimensional grating RG (hereinbelow, simply called a “grating”) that serves as a measurement surface is disposed horizontally (i.e., parallel to the front surface of the wafer W) on the upper surface of the main body part 81 in an area whose circumference is larger than the wafer W. The grating RG comprises a reflective diffraction grating whose directions of periodicity are oriented in the X axial directions (i.e., an X diffraction grating) and a reflective diffraction grating whose directions of periodicity are oriented in the Y axial directions (i.e., a Y diffraction grating).

The upper surface of the grating RG is covered by a protective member, for example, a cover glass 84. In the present embodiment, the electrostatic chucking mechanism (discussed above), which chucks the wafer holder, is provided to the upper surface of the cover glass 84. Furthermore, in the present embodiment, the cover glass 84 is provided such that it covers substantially the entire surface of the upper surface of the main body part 81, but the cover glass may be provided such that it covers only the part of the upper surface of the main body part 81 that includes the grating RG. In addition, the protective member (i.e., the cover glass 84) may be formed from the same raw material as that of the main body part 81, but the present invention is not limited thereto; for example, the protective member may be formed from, for example, a metal or a ceramic material, or a configuration may be adopted wherein the protective member is formed as a thin film or the like.

As can be understood also from FIG. 4A, the main body part 81 is, as a whole, an octagonal plate shaped member wherein overhanging parts that protrude toward the outer side from both end parts in the longitudinal directions are formed, and a recessed part is formed in the bottom surface of the main body part 81 at the portion that opposes the grating RG. The center area of the main body part 81 at which the grating RG is disposed is formed as a plate with a substantially uniform thickness.

As shown in FIG. 4A and FIG. 4B, the slider part 82a comprises two plate shaped members 82a₁, 82a₂, which are rectangular in a plan view and whose size in the Y axial directions (i.e., length) and size in the X axial directions (i.e., width) are both smaller than that of the stator part 93a. The plate shaped members 82a₁, 82a₂ are fixed to the +X side end part of the main body part 81 in the state wherein they are spaced apart from one another by a prescribed distance in the Z axial directions (i.e., the vertical directions) and such that they are parallel to the XY plane. The −X side end part of the stator part 93a is noncontactually inserted between the two plate shaped members 82a₁, 82a₂. The plate shaped members 82a₁, 82a₂ respectively house magnet units MUa₁, MUa₂ (discussed below).

The slider part 82b comprises two plate shaped members 82b₁, 82b₂, which are maintained at a prescribed spacing in the Z axial directions (i.e., the vertical directions), and is bilaterally symmetric with and configured identically to the slider part 82a. The +X side end part of the stator part 93b is inserted noncontactually between the two plate shaped members 82b₁, 82b₂. Magnet units MUb₁, MUb₂, which are configured identically to the magnet units MUa₁, MUa₂, are housed inside the plate shaped members 82b₁, 82b₂.

Here, as discussed above, both side surfaces of the coarse motion stages WCS in the Y axial directions are open; therefore, when the fine motion stage WFS is mounted to the coarse motion stages WCS, the fine motion stage WFS should be positioned in the Z axial directions such that the stator parts 93a, 93b are positioned between the plate shaped members 82a₁, 82a₂ and 82b₁, 82b₂, respectively; subsequently, the fine motion stage WFS should be moved (i.e., slid) in the Y axial directions.

The fine motion stage drive system 52 comprises: the pair of magnet units MUa₁, MUa₂, which are provided by the slider part 82a (discussed above); the coil unit CUa, which is provided by the stator part 93a; the pair of magnet units MUb₁, MUb₂, which is provided by the slider part 82b (discussed above); and the coil unit CUb, which is provided by the stator part 93b.

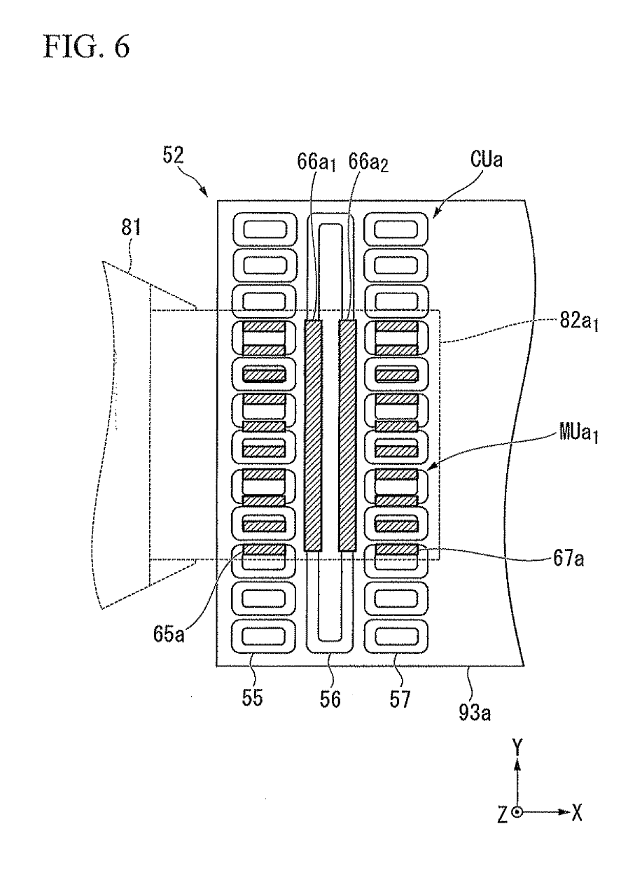

This will now be discussed in more detail. As can be understood from FIG. 6, a plurality of YZ coils 55, 57 (here, 12 each; hereinbelow, abbreviated as “coils” where appropriate), which are oblong in a plan view, are disposed equispaced in the Y axial directions inside the stator part 93a such that they constitute a two column coil array, The two columns of the coil array are disposed with a prescribed spacing between them in the X axial directions. Each of the YZ coils 55 comprises an upper part winding and a lower part winding (not shown), which are rectangular in a plan view and disposed such that they overlap in the vertical directions (i.e., the Z axial directions). In addition, one X coil 56 (hereinbelow, abbreviated as “coil” where appropriate), which in a plan view is a long, thin oblong whose longitudinal directions are oriented in the Y axial directions, is disposed inside the stator part 93a and between the columns of the two-column coil array discussed above. In this case, each of the columns of the two-column coil array and the X coil 56 are disposed equispaced in the X axial directions, Together, the two-column coil array and the X coil 56 constitute the coil unit CUa.

Furthermore, the following text explains the stator part 93a and the slider part 82a, which have the coil unit CUa and the magnet units MUa₁, MUa₂, respectively, referencing FIG. 6; the other stator and slider, that is, the stator part 93b and the slider part 82b, are similarly configured and function in the same manner.

As can be understood by referencing FIG. 6, a plurality of permanent magnets 65a, 67a (herein, 10 of each), which are oblong in a plan view and whose longitudinal directions are oriented in the X axial directions, are disposed equispaced in the Y axial directions inside the +Z side plate shaped member 82a₁, which constitutes part of the slider part 82a, and thereby constitute a two-column magnet array. The two columns of the magnet array are disposed spaced apart from one another by a prescribed spacing in the X axial directions and such that they oppose the coils 55, 57. In addition, two permanent magnets 66a₁, 66a₂, which are disposed spaced apart in the X axial directions and whose longitudinal directions are oriented in the Y axial directions, are disposed inside the plate shaped member 82a₁ between the columns of the two-column magnet array discussed above such that they oppose the coil 56.

The permanent magnets 65a are arrayed such that their directions of polarity alternate. The magnet column that comprises the plurality of the permanent magnets 67a is configured identically to the magnet column that comprises the plurality of the permanent magnets 65a. In addition, the permanent magnets 66a₁, 66a₂ are disposed such that their polarities are the opposite of one another. The plurality of the permanent magnets 65a, 67a and 66a₁, 66a₂ constitutes the magnet unit MUa₁.

As in the plate shaped member 82a₁ discussed above, permanent magnets also are disposed inside the plate shaped member 82a₂ on the −Z side, and these permanent magnets constitute the magnet unit MUa₂.

Here, the positional relationship in the Y axial directions between the permanent magnets 65a, which are disposed adjacently in the Y axial directions, and the YZ coils 55 (i.e., the relationship of the spacings between them) is set such that, when the two adjacent permanent magnets 65a (called “first and second permanent magnets” for the sake of convenience) oppose the winding parts of the YZ coils 55 (called “first YZ coils” for the sake of convenience), the third permanent magnet 65a adjacent to the second permanent magnet 65a does not oppose the winding part of the second YZ coil 55 adjacent to the first YZ coil 55 discussed above (i.e., the positional relationship is set either such that the third permanent magnet 65a opposes the hollow part at the center of the coil or such that it opposes the core, for example, the iron core, around which the coil is wound). In such a case, the fourth permanent magnet 65a, which is adjacent to the third permanent magnet 65a, and the fifth permanent magnet 65a each oppose the winding part of the. third YZ coil 55, which is adjacent to the second YZ coil 55. This likewise applies to the spacing in the Y axial directions between the permanent magnets 67a and the two column permanent magnet array inside the plate shaped member 82a₂ on the −Z side.

Because the present embodiment adopts the arrangement of the coils and permanent magnets as discussed above, the main control apparatus 20 can drive the fine motion stage WFS in the Y axial directions by supplying an electric current to every other coil of the plurality of the YZ coils 55, 57 arrayed in the Y axial directions. In addition, in parallel therewith, the main control apparatus 20 can levitate the fine motion stage WFS above the coarse motion stages WCS through generating driving forces in the Z axial directions that are separate from the driving forces in the Y axial directions by supplying electric currents to coils of the YZ coils 55, 57 that are not used to drive the fine motion stage WFS in the Y axial directions. Furthermore, by sequentially switching, in accordance with the position of the fine motion stage WFS in the Y axial directions, which of the coils are supplied with electric current, the main control apparatus 20 drives the fine motion stage WFS in the Y axial directions while maintaining the state wherein the fine motion stage WFS is levitated above the coarse motion stages WCS, namely, a noncontactual state. In addition, in the state wherein the fine motion stage WFS is levitated above the coarse motion stages WCS, the main control apparatus 20 can also drive the fine motion stage WFS independently in the X axial directions in addition to the Y axial directions.

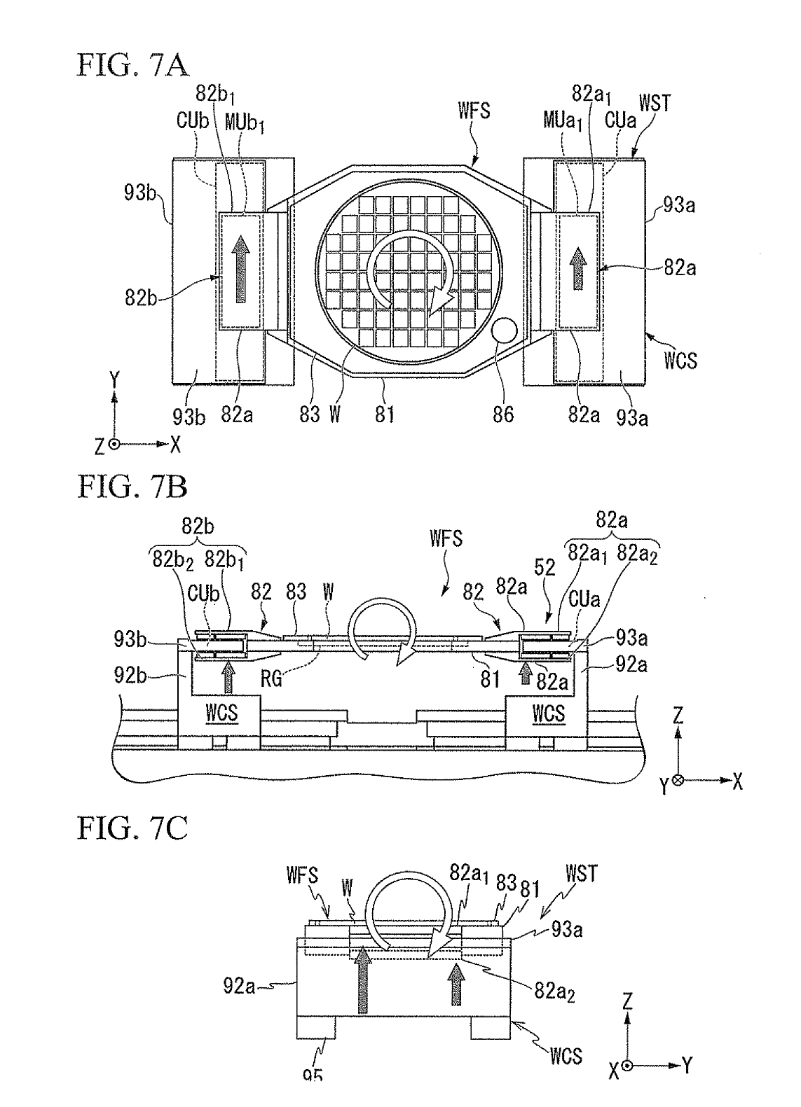

In addition, as shown in, for example, FIG. 7A, the main control apparatus 20 can rotate the fine motion stage WFS around the Z axis (i.e., can perform θz rotation; refer to the outlined arrow in FIG. 7A) by causing driving forces (i.e., thrusts) in the Y axial directions of differing magnitudes to act on the slider part 82a and the slider part 82b (refer to the solid arrows in FIG. 7A). Furthermore, the fine motion stage WFS can be rotated counterclockwise around the Z axis by, in a method the reverse of that described in FIG. 7A, making the driving force that acts on the slider part 82a on the +X side larger than the driving force that acts on the slider part 82a on the −X side.

In addition, as shown in FIG. 7B, the main control apparatus 20 can rotate the fine motion stage WFS around the Y axis (i.e., can perform θy drive; refer to the outlined arrow in FIG. 7B) by causing levitational forces of differing magnitudes to act on the slider part 82a and the slider part 82b (refer to the solid arrows in FIG. 7B). Furthermore, the fine motion stage WFS can be rotated counterclockwise around the Y axis by, in a method the reverse of that described in FIG. 7B, making the levitational forces that act on the slider part 82a greater than the levitational forces that act on the slider part 82b.

Furthermore, as shown in, for example, FIG. 7C, the main control apparatus 20 can rotate the fine motion stage WFS around the X axis (i.e., can perform θx drive; refer to the outlined arrow in FIG. 7C) by causing levitational forces of differing magnitudes to act on the +Y side and the −Y side slider parts 82a, 82b in the Y axial directions (refer to the solid arrows in FIG. 7C). Furthermore, the fine motion stage WFS can be rotated counterclockwise around the X axis by, in a method the reverse of that described in FIG. 7C, making the levitational force that acts on the −Y side portion smaller than the levitational force that acts on the +Y side portion of the slider parts 82a (and 82b).

As is understood from the explanation above, in the present embodiment, the fine motion stage drive system 52 (i.e., first and second drive parts) can levitationally support the fine motion stage WFS in a noncontactual state above the coarse motion stages WCS and can drive the coarse motion stages WCS noncontactually in directions corresponding to six degrees of freedom (i.e., in the X, Y, Z, θx, θy, and θz directions).

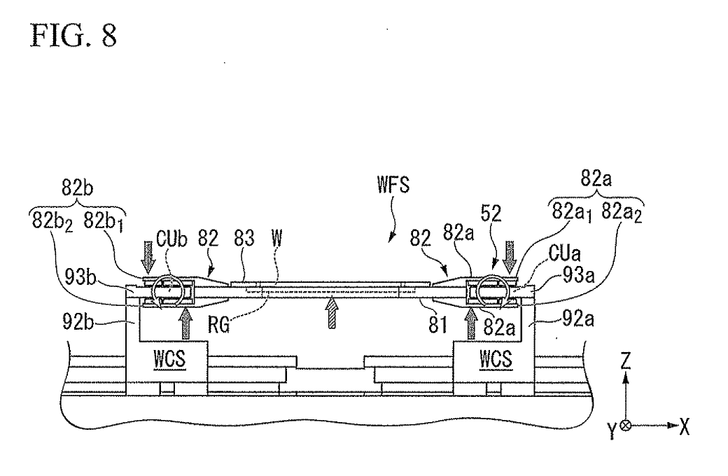

In addition, in the present embodiment, when levitational forces are caused to act on the fine motion stage WFS, the main control apparatus 20 can cause a rotational force around the Y axis to act on the slider part 82a (refer to the outlined arrow in FIG. 8) at the same time that levitational forces act on the slider part 82a (refer to the solid arrow in FIG. 8), as shown in, for example, FIG. 8, by supplying electric currents in opposite directions to the two columns of coils 55, 57 (refer to FIG. 6) disposed inside the stator part 93a. Similarly, when levitational forces are caused to act on the fine motion stage WFS, the main control apparatus 20 can cause a rotational force around the Y axis to act on the slider part 82a at the same time that levitational forces act on the slider part 82a by supplying electric currents in opposite directions to the two columns of coils 55, 57 disposed inside the stator part 93b.

In addition, the main control apparatus 20 can flex in the +Z direction or the −Z direction (refer to the hatched arrow in FIG. 8) the center part of the fine motion stage WFS in the X axial directions by causing rotational forces around the Y axis (i.e., in the θy directions) to act on the slider parts 82a, 82b in opposite directions. Accordingly, as shown in FIG. 8, it can ensure a degree of parallelism between the front surface of the wafer W and the XY plane (i.e., the horizontal plane) by flexing in the +Z direction (i.e., by causing to protrude) the center part of the fine motion stage WFS in the X axial directions and thereby canceling the flexure in the X axial directions of an intermediate portion of the fine motion stage WFS (i.e., the main body part 81) owing to the self weights of the wafer W and the main body part 81. Thereby, this aspect is particularly effective when, for example, the size of the wafer W or of the fine motion stage WFS is increased.

In the exposure apparatus 100 of the present embodiment, when a step-and-scan type exposure operation is being performed on the wafer W, the main control apparatus 20 uses an encoder system 73 (refer to FIG. 5) of the fine motion stage position measuring system 70 (discussed below) to measure the position within the XY plane (including the position in the θz directions) of the fine motion stage WFS. The positional information of the fine motion stage WFS is sent to the main control apparatus 20, which, based thereon, controls the position of the fine motion stage WFS.

In contrast, when the wafer stage WST is outside of the measurement area of the fine motion stage position measuring system 70, the main control apparatus 20 uses the wafer stage position measuring system 16 (refer to FIG. 5) to measure the position of the wafer stage WST. As shown in FIG. 1, the wafer stage position measuring system 16 comprises laser interferometers, which radiate length measuring beams to reflective surfaces on the side surfaces of the coarse motion stages WCS, and measures the position within the XY plane (including the rotation in the θz directions) of the wafer stage WST. Furthermore, instead of using the wafer stage position measuring system 16 discussed above to measure the position within the XY plane of the wafer stage WST, some other measuring apparatus, for example, an encoder system, may be used.

As shown in FIG. 1, the fine motion stage position measuring system 70 comprises a measuring arm 71, which is inserted in the space inside each of the coarse motion stages WCS in the state wherein the wafer stage WST is disposed below the projection optical system PL. The measuring arm 71 is supported in a cantilevered state by the main frame BD via a support part 72 (i.e., the vicinity of one-end part is supported).

The measuring arm 71 is a square columnar member (i.e., a rectangular parallelepipedic member) whose longitudinal directions are oriented in the Y axial directions and whose longitudinal oblong cross section is such that the size in the height directions (i.e., the Z axial directions) is greater than the size in the width directions (i.e., the X axial directions); furthermore, the measuring arm 71 is formed from the identical raw material wherethrough the light transmits, for example, by laminating together a plurality of glass members. The measuring arm 71 is formed as a solid, excepting the portion wherein the encoder head (i.e., the optical system) is housed (discussed below). As discussed above, a tip part of the measuring arm 71 is inserted in the spaces of the coarse motion stages WCS in the state wherein the wafer stage WST is disposed below the projection optical system PL; furthermore, as shown in FIG. 1, the upper surface of the measuring arm 71 opposes the lower surface of the fine motion stage WFS (more accurately, the lower surface of the main body part 81; not shown in FIG. 1; refer to FIG. 2 and the like). The upper surface of the measuring arm 71 is disposed substantially parallel to the lower surface of the fine motion stage WFS in the state wherein a prescribed clearance, for example, approximately several millimeters, is formed between the upper surface of the measuring arm 71 and the lower surface of the fine motion stage WFS.

As shown in FIG. 5, the fine motion stage position measuring system 70 comprises the encoder system 73 and the laser interferometer system 75. The encoder system 73 comprises an X linear encoder 73x, which measures the position of the fine motion stage WFS in the X axial directions, and a pair of Y linear encoders 73ya, 73yb, which measures the position of the fine motion stage WFS in the Y axial directions. The encoder system 73 uses diffraction interference type heads with a configuration identical to that of the encoder head (herein below, abbreviated as “head” where appropriate) disclosed in, for example, U.S. Pat. No. 7,238,931 and U.S. Patent Application Publication No. 2007/288,121. However, in the head of the present embodiment, the light source discussed above and a light receiving system (including a photodetector) are disposed outside of the measuring arm 71 (as discussed below), and only the optical system is disposed inside the measuring arm 71, namely, opposing the grating RG. Unless it is particularly necessary to use its full name, the optical system disposed inside the measuring arm 71 is called a head.

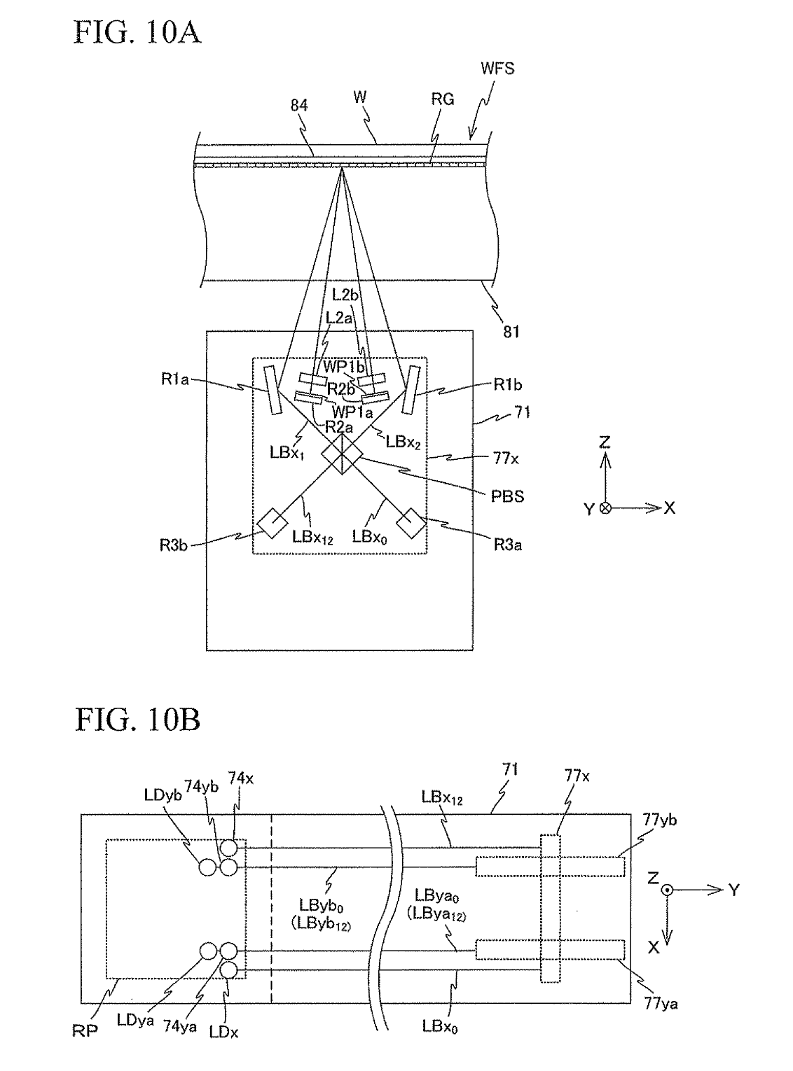

The encoder system 73 uses one X head 77x (refer to FIG. 10A and FIG. 10B) to measure the position of the fine motion stage WFS in the X axial directions, and uses a pair of Y heads 77ya, 77yb (refer to FIG. 10B) to measure the position of the fine motion stage WFS in the Y axial directions. Namely, the X linear encoder 73x (discussed above) comprises the X head 77x that uses the X diffraction grating of the grating RG to measure the position of the fine motion stage WFS in the X axial directions, and the pair of Y linear encoders 73ya, 73yb comprises the pair of Y heads 77ya, 77yb that uses the Y diffraction grating of the grating RG to measure the position of the fine motion stage WFS in the Y axial directions.

Here, the configuration of the three heads 77x, 77ya, 77yb that constitute the encoder system 73 will be explained. FIG. 10A shows a schematic configuration of the X head 77x, which represents all three of the heads 77x, 77ya, 77yb. In addition, FIG. 10B shows the arrangement of the X head 77x and the Y heads 77ya, 77yb inside the measuring arm 71.

As shown in FIG. 10A, the X head 77x comprises a polarizing beam splitter PBS, a pair of reflective mirrors Rla, Rib, a pair of lenses L2a, L2b, a pair of quarter wave plates WP1a, WP1b (hereinbelow, denoted as λ/4 plates), a pair of reflective mirrors R2a, R2b, and a pair of reflective mirrors R3a, R3b; furthermore, these optical elements are disposed with prescribed positional relationships. The optical systems of the Y heads 77ya, 77yb also have the same configuration. As shown in FIG. 10A and FIG. 10B, the X head 77x and the Y heads 77ya, 77yb are each unitized and fixed inside the measuring arm 71.

As shown in FIG. 10B, in the X head 77x (i.e., the X encoder 73x), a light source LDx, which is provided to the upper surface of the −Y side end part of the measuring arm 71 (or there above), emits in the −Z direction a laser beam LBx₀, the laser beam LBx₀ transits a reflective surface RP, which is provided to part of the measuring arm 71 such that the reflective surface RP is tilted at a 45° angle with respect to the XY plane, and the optical path of the laser beam LBx₀ is thereby folded in a direction parallel to the Y axial directions. The laser beam LBx₀ advances parallel to the Y axial directions through the solid portion inside the measuring arm 71 and reaches the reflective mirror R3a (refer to FIG. 10A). Furthermore, the reflective mirror R3a folds the optical path of the laser beam LBx₀, and the laser beam LBx₀ thereby impinges the polarizing beam splitter PBS. The polarizing beam splitter PBS polarizes and splits the laser beam LBx₀, which becomes two measurement beams LBx₁, LBx₂. The measurement beam LBx₁, which transmits through the polarizing beam splitter PBS, reaches the grating RG, which is formed in the fine motion stage WFS, via the reflective mirror Rla; furthermore, the beam LBx₂, which is reflected by the polarizing beam splitter PBS, reaches the diffraction grating RG via the reflective mirror R1b. Furthermore, “polarization splitting” herein means the splitting of the incident beam into a P polarized light component and an S polarized light component.

Diffraction beams of a prescribed order (e.g., first order diffraction beams), which are generated by the grating RG as a result of the radiation of the beams LBx₁, LBx₂, transit the lenses L2a, L2b, are converted to circularly polarized beams by the λ/4 plates WP1a, WP1b, are subsequently reflected by the reflective mirrors R2a, R2b, pass once again through the λ/4 plates WP1a, WP1b, and reach the polarizing beam splitter PBS by tracing the same optical path as the forward path, only in reverse.

The polarized directions of each of the two first order diffraction beams that reach the polarizing beam splitter PBS are rotated by 90° with respect to the original directions. Consequently, the first order diffraction beams of the measurement beams LBx₁, LBx₂ are combined coaxially as a combined beam LBx₁₂. The reflective mirror R3b folds the optical path of the combined beam LBx₁₂ such that it is parallel to the Y axis, after which the combined beam LBx₁₂ travels parallel to the Y axis inside the measuring arm 71, transits the reflective surface RP (discussed above), and is sent to an X light receiving system 74x, which is provided to the upper surface of the side end part of the measuring arm 71 (or there above), as shown in FIG. 1 OB.

In the X light receiving system 74x, the first order diffraction beams of the measurement beams LBx₁, LBx₂, which were combined into the combined beam LBx₁₂, are aligned in polarization directions by a polarizer (i.e., an analyzer), which is not shown, and therefore interfere with one another to form an interfered beam, which is detected by the photodetector (not shown) and then converted to an electrical signal that corresponds to the intensity of the interfered beam. Here, when the fine motion stage WFS moves in either of the measurement directions (in this case, the X axial directions), the phase difference between the two beams changes, and thereby the intensity of the interfered beam changes. These changes in the intensity of the interfered beam are supplied to the main control apparatus 20 (refer to FIG. 5) as the positional information in the X axial directions of the fine motion stage WFS.

As shown in FIG. 10B, laser beams LBya₀, LByb₀ are emitted from light sources LDya, LDyb and the reflective surface RP (discussed above) folds the optical paths of the laser beams LBya₀, LByb₀ by 90°, after which the laser beams LBya₀, LByb₀ are parallel to the Y axis and enter into the Y heads 77ya, 77yb. Combined beams LBya₁₂, LByb₁₂ of the first order diffraction beams, which have been polarized and split by the polarizing beam splitters and the grating RG (i.e., the Y diffraction gratings) as discussed above, are output from the Y heads 77ya, 77yb, and return to Y light receiving systems 74ya, 74yb. Here, the laser beams LBya₀, LByb₀, which were emitted from the light sources LDya, LDyb, and the combined beams LBya₁₂, LByb₁₂, which return to the Y light receiving systems 74ya, 74yb, travel with overlapping optical paths in the directions perpendicular to the paper plane in FIG. 10B. In addition, as discussed above, inside the Y heads 77ya, 77yb, the optical paths of the laser beams LBya₀, LByb₀ emitted from the light sources and the optical paths of the combined beams LBya₁₂, LByb₁₂ that return to the Y light receiving systems 74ya, 74yb are folded as appropriate (not shown) such that those optical paths are parallel and spaced apart in the Z axial directions.

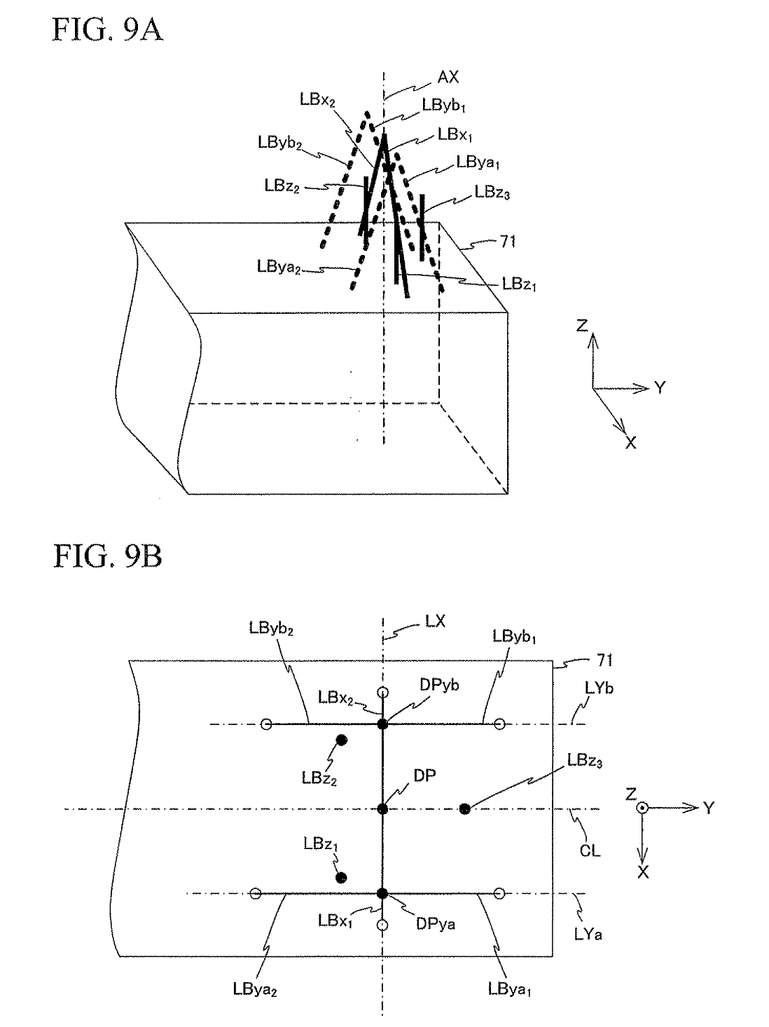

FIG. 9A is an oblique view of the tip part of the measuring arm 71, and FIG. 9B is a plan view, viewed from the +Z direction, of the upper surface of the tip part of the measuring arm 71. As shown in FIG. 9A and FIG. 9B, the X head 77x radiates the measurement beams LBx₁, LBx₂ (indicated by solid lines in FIG. 9A) from two points (refer to the white circles in FIG. 9B), which are equidistant from a centerline CL of the measuring arm 71 along a straight line LX parallel to the X axis, to the identical irradiation point on the grating RG (refer to FIG. 10A). The irradiation point of the measurement beams LBx₁, LBx₂, namely, the detection point of the X head 77x (refer to symbol DP in FIG. 9B) coincides with the exposure position (refer to FIG. 1), which is the center of the irradiation area IA (i.e., the exposure area) of the illumination light IL radiated to the wafer W. Furthermore, although the measurement beams LBx₁, LBx₂ are in actuality refracted by, for example, the interface surface between the main body part 81 and the air layer, this aspect is shown in a simplified form in FIG. 10A and the like.

As shown in FIG. 10B, the Y heads 77ya, 77yb are disposed on the +X side and the −X side of the centerline CL. As shown in FIG. 9A and FIG. 9B, the Y head 77ya radiates measurement beams LBya₁, LBya₂, which are indicated by broken lines in FIG. 9A, from two points (refer to the white circles in FIG. 9B), which are equidistant from the straight line LX along a straight line LYa, to a common irradiation point on the grating RG. The irradiation point of the measurement beams LBya₁, LBya₂, namely, the detection point of the Y head 77ya, is indicated by a symbol DPya in FIG. 9B.

The Y head 77yb radiates measurement beams LByb₁, LByb₂ from two points (refer to the white circles in FIG. 9B), which are symmetric to the emitting points of the measurement beams LBya₁, LBya₂ of the Y head 77ya with respect to the centerline CL, to a common irradiation point DPyb on the grating RG.

As shown in FIG. 9B, the detection points DPya, DPyb of the Y heads 77ya, 77yb are disposed along the straight line LX, which is parallel to the X axis.

Here, the main control apparatus 20 determines the position of the fine motion stage WFS in the Y axial directions based on the average of the measurement values of the two Y heads 77ya, 77yb. Accordingly, in the present embodiment, the position of the fine motion stage WFS in the Y axial directions is measured such that the midpoint DP of the detection points DPya, DPyb substantially serves as the measurement point. The midpoint DP coincides with the irradiation point of the measurement beams LBx₁, LBx₂ on the grating RG

Namely, in the present embodiment, the positional measurements of the fine motion stage WFS in the X axial directions and the Y axial directions have a common detection point and this detection point coincides with the exposure position, which is the center of the irradiation area IA (i.e., the exposure area) of the illumination light IL radiated to the wafer W. Accordingly, in the present embodiment, the main control apparatus 20 can use the encoder system 73 to continuously measure directly below the exposure position (i.e., on the rear surface side of the fine motion stage WFS)—the position of the fine motion stage WFS within the XY plane when the pattern of the reticle R is transferred to a prescribed shot region on the wafer W mounted on the fine motion stage WFS. In addition, the main control apparatus 20 measures the amount of rotation of the fine motion stage WFS in the θz directions based on the difference in the measurement values of the two Y heads 77ya, 77yb.

As shown in FIG. 9A, the laser interferometer system 75 causes three length measuring beams LBz₁, LBz₂, LBz₃ to emerge from the tip part of the measuring arm 71 and impinge the lower surface of the fine motion stage WFS. The laser interferometer system 75 comprises three laser interferometers 75a-75c (refer to FIG. 5), each of which radiates one of these three length measuring beams LBz₁, LBz₂, LBz₃.

As shown in FIG. 9A and FIG. 9B, in the laser interferometer system 75, the center of gravity of the three length measuring beams LBz₁, LBz₂, LBz₃ coincides with the exposure position, which is the center of the irradiation area IA (i.e., the exposure area), and the length measuring beams LBz₁, LBz₂, LBz₃ are emitted parallel to the Z axis from three points that correspond to the vertices of an isosceles triangle (or a regular triangle). In this case, the emitting point (i.e., the radiation point) of the length measuring beam LBz₃ is positioned along the centerline CL, and the emitting points (i.e., the radiation points) of the remaining length measuring beams LBz₁, LBz₂ are equidistant from the centerline CL. In the present embodiment, the main control apparatus 20 uses the laser interferometer system 75 to measure the position in the Z axial directions and the amounts of rotation in the θz and θy directions of the fine motion stage WFS. Furthermore, the laser interferometers 75a-75c are provided to the upper surface of the −Y side end part of the measuring arm 71 (or there above). The length measuring beams LBz₁, LBz₂, LBz₃, which are emitted in the −Z direction from the laser interferometers 75a-75c transit the reflective surface RP (discussed above), travel along the Y axial directions inside the measuring arm 71, wherein their optical paths are folded, and emerge from the three points discussed above.

In the present embodiment, a wavelength selecting filter (not shown), which transmits the measurement beams from the encoder system 73 but hinders the transmission of the length measuring beams from the laser interferometer system 75, is provided to the lower surface of the fine motion stage WFS. In this case, the wavelength selecting filter serves double duty as the reflective surface of the length measuring beams from the laser interferometer system 75.

As can be understood from the explanation above, using the encoder system 73 of the fine motion stage position measuring system 70 and the laser interferometer system 75, the main control apparatus 20 can measure the position of the fine motion stage WFS in directions corresponding to six degrees of freedom. In this case, in the encoder system 73, the in-air optical path lengths of the measurement beams are extremely short and substantially equal, and consequently the effects of air turbulence are virtually inconsequential. Accordingly, the encoder system 73 can measure, with high accuracy, the position of the fine motion stage WFS within the XY plane (including the θz directions). In addition, because, within the XY plane, the detection point of the encoder system 73 on the grating RG in the X axial directions and in the Y axial directions and the detection point of the laser interferometer system 75 on the lower surface of the fine motion stage WFS in the Z axial directions substantially coincide with the center (i.e., the exposure position) of the exposure area IA, so-called Abbé error owing to a shift between the detection point and the exposure position within the XY plane is suppressed to such a degree that it is substantially inconsequential. Accordingly, using the fine motion stage position measuring system 70, the main control apparatus 20 can measure, with high accuracy, the position of the fine motion stage WFS in the X axial directions, the Y axial directions, and the Z axial directions without Abbé error resulting from a shift between the detection point and the exposure position within the XY plane.

However, in the Z axial directions parallel to the optical axis of the projection optical system PL, the encoder system 73 does not measure the position of the fine motion stage WFS within an XY plane that includes the position of the front surface of the wafer W, namely, it is not the case that the Z position of the installation surface of the grating RG and the Z position of the front surface of the wafer W coincide. Accordingly, if the grating RG (i.e., the fine motion stage WFS) is tilted with respect to the XY plane and the fine motion stage WFS is positioned based on the measurement values of the encoders of the encoder system 73, then unfortunately, as a result, positioning errors (i.e., each a type of Abbé error) will be generated in accordance with the tilt of the grating RG with respect to the XY plane owing to a Z position difference ΔZ between the installation surface of the grating RG and the front surface of the wafer W (i.e., the mispositioning in the Z axial directions of the detection point of the encoder system 73 and the exposure position). Nevertheless, these positioning errors (i.e., positional control errors) can be derived by simple calculations using the difference ΔZ, the amount of pitching θx, and the amount of rolling θy, the results of the calculations can be used as offsets, and the effects of the abovementioned type of Abbé error can be eliminated by positioning the fine motion stage WFS based on corrected positional information, wherein the measurement values of the encoder system 73 (i.e., each encoder thereof) are corrected by the offsets.

In addition, in the configuration of the encoder system 73 of the present embodiment, measurement errors can be generated owing to displacement of the grating RG (i.e., the fine motion stage WFS) in the nonmeasurement directions, particularly in the tilt (θx, θy) and rotation (θz) directions. Accordingly, the main control apparatus 20 generates correctional information in order to correct the measurement errors. Here, as one example, a method of generating the correctional information for correcting the measurement error of the X encoder 73x will be explained. Furthermore, in the configuration of the encoder system 73 of the present embodiment, it is to be understood that measurement errors owing to the displacement of the fine motion stage WFS in the X, Y, and Z directions are not generated.

a. The main control apparatus 20 first controls the coarse motion stage drive system 51 while using the wafer stage position measuring system 16 to monitor the position of the wafer stage WST and drives the fine motion stage WFS, together with the coarse motion stages WCS, within the measurement area of the X encoder 73x.

b. Next, based on the measurement results of the laser interferometer system 75 and the Y encoders 73ya, 73yb, the main control apparatus 20 controls the fine motion stage drive system 52 and fixes an amount of rolling θy and an amount of yawing θz of the fine motion stage WFS to zero and the amount of pitching θx of the fine motion stage WFS to a prescribed amount (e.g., 200 μrad).

c. Next, the main control apparatus 20 controls the fine motion stage drive system 52 based on the measurement results of the laser interferometer system 75 and the Y encoders 73ya, 73yb, drives the fine motion stage WFS in the Z axial directions within a prescribed range (e.g., −100 to +100 μm) while maintaining the attitude (i.e., amount of pitching θx, amount of rolling θy=0, and amount of yawing θz=0) of the fine motion stage WFS, and uses the X encoder 73x to measure the position of the fine motion stage WFS in the X axial directions.

d. Next, the main control apparatus 20 controls the fine motion stage drive system 52 based on the measurement results of the laser interferometer system 75 and the Y encoders 73ya, 73yb and varies the amount of pitching θx within a prescribed range, for example, −200 to +200 μrad, while maintaining the amount of rolling θy and the amount of yawing θz of the fine motion stage WFS as is, Here, the amount of pitching θx is varied by a prescribed step size Δθx. Furthermore, a process identical to the process described in c above is performed for each amount of pitching θx.

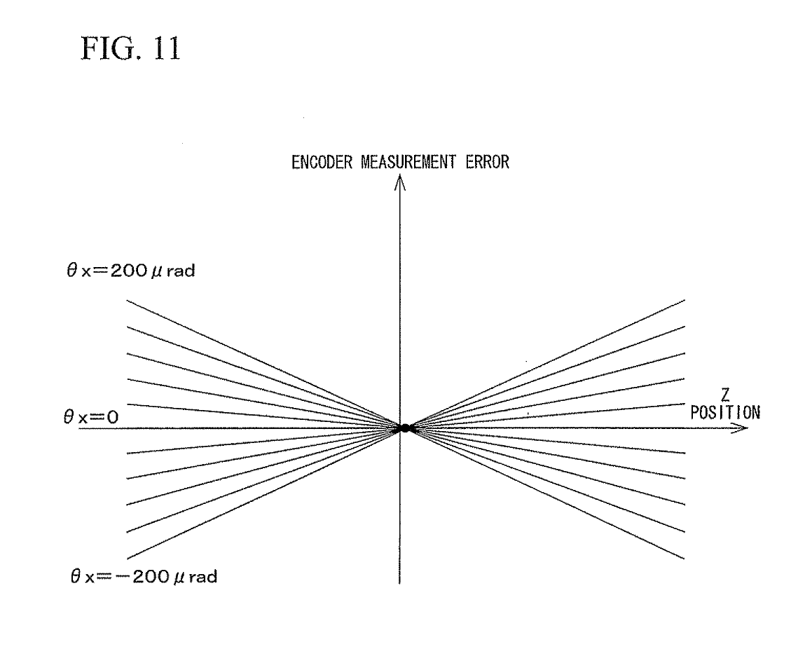

e. The processes b-d discussed above obtain the results of the measurements of the X encoder 73x in the θx and Z directions when θy=0 and θz=0. As shown in FIG. 11, these measurement results are plotted for each amount of pitching θx, wherein the abscissa represents the Z position of the fine motion stage WFS and the ordinate represents the measurement value of the X encoder 73x. Thereby, by connecting the plot points for each of the amounts of pitching θx, multiple straight lines with different tilts are obtained, and the intersection point of these straight lines indicates the true measurement value of the X encoder 73x. Accordingly, by choosing the intersection point as the origin, the ordinate can instead be read as the measurement error of the X encoder 73x. Here, at the origin, the Z position is defined as Zx0. The measurement error of the X encoder 73x in the θx and Z directions when θy=0 and θz=0, which is obtained by the above processes, is defined as θx correctional information.

f. As in the processes b-d discussed above, the main control apparatus 20 fixes both the amount of pitching θx and the amount of yawing θz of the fine motion stage WFS to zero and varies the amount of rolling θy of the fine motion stage WFS. Furthermore, for each θy, the fine motion stage WFS is driven in the Z axial directions and the X encoder 73x is used to measure the position of the fine motion stage WFS in the X axial directions. As in FIG. 11, the results so obtained when θx=0 and θz=0 are plotted for each θy against the Z position of the fine motion stage WFS and the measurement value of the X encoder 73x. Furthermore, the plot points are connected for each amount of rolling θy and the intersection point of the straight lines with different tilts so obtained is chosen as the origin, namely, the measurement value of the X encoder 73x corresponding to the intersection point is defined as the true measurement value, and the deviation from this true measurement value is defined as the measurement error. Here, the Z position at the origin is defined as Zy0. The measurement error of the X encoder 73x in the θy and Z directions when θx=0 and θz=0, which is obtained by the above processes, is defined as θy correctional information.

g. As in the processes b-d and fdiscussed above, the main control apparatus 20 derives the measurement error of the X encoder 73x in the θz and Z directions when θx=0 and θy=0. Furthermore, as described above, the Z position at the origin is defined as Zz0. The measurement error obtained by these processes is defined as θz correctional information.

Furthermore, the θx correctional information may be stored in memory in the form of a table that lists the measurement error of each discrete encoder for each measurement point against the amount of pitching θx and the Z position. Alternatively, trial functions may be assigned to the amount of pitching θx and the Z position, which indicate the measurement errors of the encoders, and, based on the measurement errors of the encoders, the undetermined multipliers of the trial functions may be determined using the least squares method. Furthermore, the trial functions so obtained may be used as the correctional information. The same applies to the fly and θz correctional information.

Furthermore, the measurement errors of the encoders generally depend on all of the following: the amount of pitching θx, the amount of rolling θy, and the amount of yawing θz. However, the degrees of mutual dependency are known to be small. Accordingly, the measurement errors of the encoders owing to changes in the attitude of the grating RG can be considered independently dependent on θx, θy, and θz. Namely, the measurement errors of the encoders owing to changes in the attitude of the grating RG (i.e., the total measurement error) can be defined as the linear sum of the θx, θy, and θz measurement errors, for example, in the form shown in equation (1) below.

$$\begin{matrix}Δ x = Δ x ( Z , θ x , θ y , θ z ) \\ = θ x ( Z - {Z}_{x 0} ) + θ y ( Z - {Z}_{y 0} ) + θ z ( Z - {Z}_{z 0} )\end{matrix} \qquad ( 1 )$$

In accordance with a procedure identical to the one used to generate the correctional information discussed above, the main control apparatus 20 generates correctional information (i.e., θx correctional information, θy correctional information, and θz correctional information) for correcting the measurement errors of the Y encoders 73ya, 73yb. Total measurement error Δy=Δy (Z, θx, θy, θz) can be defined in the same form as that of equation (1) above.

The main control apparatus 20 generates in advance the correctional information (i.e., the θx correctional information, the θy correctional information, and the θz correctional information) of the X encoder 73x and the Y encoders 73ya, 73yb by performing the processes above at the startup of the exposure apparatus 100, during idling, or after a prescribed number, for example, a unit quantity, of wafers has been exchanged. Furthermore, during the operation of the exposure apparatus 100, the main control apparatus 20 monitors the θx, θy, θz, and Z positions of the fine motion stage WFS and uses these measurement results to derive the amounts of error correction Δx, Δy of the X encoder 73x and the Y encoders 73ya, 73yb based on the correctional information (i.e., the θx correctional information, the θy correctional information, and the θz correctional information).

Furthermore, the main control apparatus 20 further corrects the corrected measurement values, which resulted from the correction of the measurement values of the X encoder 73x and the Y encoders 73ya, 73yb for the offsets (discussed above), using the amounts of error correction Δx, Δy, thereby correcting the measurement errors of the encoder system 73 owing to displacement of the fine motion stage WFS in the tilt (θx, θy) and rotation (θz) directions, Alternatively, these amounts of error correction and offsets may be used to correct a target position of the fine motion stage WFS. This approach also can obtain the same effects as those obtained in the case wherein the measurement error of the encoder system 73 is corrected. Furthermore, after the amounts of error correction are used to correct the measurement values of the X encoder 73x and the Y encoders 73ya, 73yb, the measurement values may be further corrected for the offsets; furthermore, the measurement values of the X encoder 73x and the Y encoders 73ya, 73yb may be corrected using the amounts of error correction and the offsets simultaneously.

In the exposure apparatus 100 of the present embodiment configured as discussed above, when a device is to be fabricated, the main control apparatus 20 first uses the wafer alignment system ALG to detect the second fiducial mark on the measuring plate 86 of the fine motion stage WFS. Next, the main control apparatus 20 uses the wafer alignment system ALG to perform wafer alignment (e.g., enhanced global alignment (EGA) and the like disclosed in, for example, U.S. Pat. No. 4,780,617) and the like. Furthermore, in the exposure apparatus 100 of the present embodiment, the wafer alignment system ALG is disposed spaced apart from the projection unit PU in the Y axial directions, and therefore the encoder system (i.e., the measuring arm 71) of the fine motion stage position measuring system 70 cannot measure the position of the fine motion stage WFS when wafer alignment is being performed, Accordingly, it is understood that the wafer is aligned while measuring the position of the wafer W (i.e., the fine motion stage WFS) via a laser interferometer system (not shown), as in the wafer stage position measuring system 16 discussed above. In addition, because the wafer alignment system ALG and the projection unit PU are spaced apart, the main control apparatus 20 converts the array coordinates of each of the shot regions on the wafer W, which were obtained as a result of the wafer alignment, to array coordinates wherein the second fiducial mark serves as a reference.

Furthermore, prior to the start of an exposure, the main control apparatus 20 uses the pair of reticle alignment systems RA₁, RA₂, the pair of first fiducial marks on the measuring plate 86 of the fine motion stage WFS, and the like, all of which were discussed above, to perform a reticle alignment using a procedure identical to that of a regular scanning stepper (e.g., the procedure disclosed in U.S. Pat. No, 5,646,413). Furthermore, based on the results of the reticle alignment and of the wafer alignment (i.e., the array coordinates of each shot region on the wafer W wherein the second fiducial mark serves as a reference), the main control apparatus 20 performs step-and-scan type exposure operations to transfer the pattern of the reticle R to the plurality of shot regions on the wafer W. These exposure operations are performed by repetitively and alternately performing a scanning exposure operation, which synchronously moves the reticle stage RST and the wafer stage WST as discussed above, and an inter-shot movement operation (i.e., stepping), which moves the wafer stage WST to an acceleration start position for exposing a shot region. In this case, the scanning exposure is performed by an immersion exposure. In the exposure apparatus 100 of the present embodiment, during the sequence of exposure operations discussed above, the main control apparatus 20 uses the fine motion stage position measuring system 70 to measure the position of the fine motion stage WFS (i.e., the wafer W), corrects the measurement value of each encoder of the encoder system 73 as discussed above, and controls the position of the wafer W within the XY plane based on the corrected measurement value of each encoder of the encoder system 73. In addition, as discussed above, the main control apparatus 20 performs the focus and leveling control of the wafer W during an exposure based on the measurement result of the multipoint AF system AF.

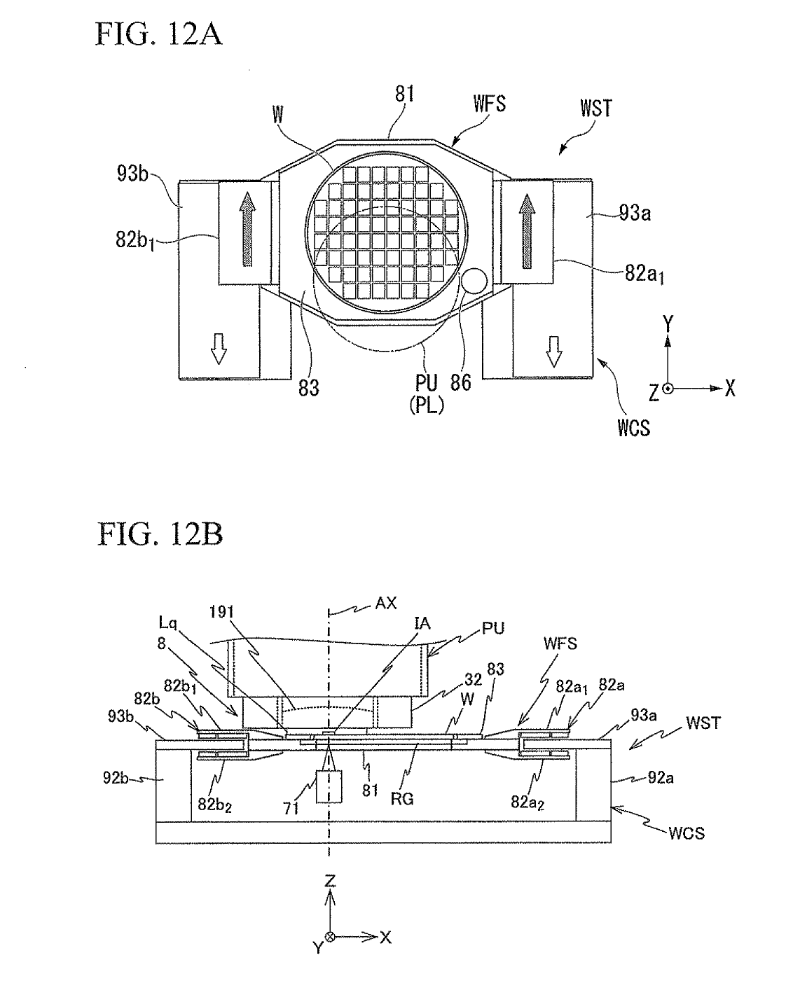

Furthermore, during the scanning exposure operation discussed above, the wafer W must be scanned in the Y axial directions at a high acceleration; however, in the exposure apparatus 100 of the present embodiment, as shown in FIG. 12A, the main control apparatus 20 scans the wafer W in the Y axial directions by driving only the fine motion stage WFS in the Y axial directions (refer to the solid arrows in FIG. 12A; and, as needed, in the directions corresponding to the other five degrees of freedom) without, as a rule, driving the coarse motion stages WCS. This is because to drive the wafer W at high acceleration, it is advantageous to drive the wafer W using only the fine motion stage WFS, which is lighter than the coarse motion stages WCS. In addition, as discussed above, the position measurement accuracy of the fine motion stage position measuring system 70 is higher than that of the wafer stage position measuring system 16, and therefore it is advantageous to drive the fine motion stage WFS during the scanning exposure. Furthermore, during the scanning exposure, the action of the reaction force (refer to the outlined arrows in FIG. 12A) generated by the drive of the fine motion stage WFS drives the coarse motion stages WCS in a direction opposite that of the fine motion stage WFS. Namely, the coarse motion stages WCS function as countermasses and conserve the momentum of the system that constitutes the entire wafer stage WST, and thereby the center of gravity does not move; therefore, the problem wherein, for example, a bias load acts on the base plate 12 owing to the drive of the fine motion stage WFS during a scan does not arise.

Moreover, when the inter-shot movement operation (i.e., stepping) is performed in the X axial directions, the fine motion stage WFS can move in the X axial directions by only a small amount; therefore, as shown in FIG. 12B, the main control apparatus 20 moves the wafer W in the X axial directions by driving the coarse motion stages WCS in the X axial directions.

According to the exposure apparatus 100 of the present embodiment as explained above, the main control apparatus 20 uses the encoder system 73 of the fine motion stage position measuring system 70 comprising the measuring arm 71 discussed above to measure the position of the fine motion stage WFS within the XY plane. In this case, because the heads of the fine motion stage position measuring system 70 are disposed in the spaces of the coarse motion stages WCS, a space exists only between these heads and the fine motion stage WFS. Accordingly, the heads can be disposed proximate to the fine motion stage WFS (i.e., the grating RG), which makes it possible to use the fine motion stage position measuring system 70 to measure with high accuracy the position of the fine motion stage WFS and, in turn, for the main control apparatus 20 to drive with high accuracy the fine motion stage WFS via the fine motion stage drive system 52 (and the coarse motion stage drive system 51). In addition, in this case, the irradiation point on the grating RG of each measurement beam emerging from the measuring arm 71 of each head of the encoder system 73 and the laser interferometer system 75—such systems constituting the fine motion stage position measuring system 70—coincides with the center (i.e., the exposure position) of the irradiation area IA (i.e., the exposure area) of the exposure light IL radiated to the wafer W. Accordingly, the main control apparatus 20 can measure with high accuracy the position of the fine motion stage WFS without being affected by so-called Abbé error owing to deviation between the detection points and the exposure position within the XY plane.

In addition, the main control apparatus 20 uses the Z position difference ΔZ between the installation surface of the grating RG and the front surface of the wafer W as well as the tilt angles θx, θy of the grating RG (i.e., the fine motion stage WFS) to derive the positioning errors (i.e., positional control errors; a type of Abbé error) that corresponds to the tilt of the grating RG with respect to the XY plane owing to the difference ΔZ, uses these errors as the offsets, and corrects the measurement values of the encoder system 73 (i.e., each encoder thereof) for the offsets. Furthermore, the main control apparatus 20 derives the amounts of error correction Δx, Δy of the X encoder 73x and the Y encoders 73ya, 73yb based on the correctional information (i.e., the 8x correctional information, the θy correctional information, and the θz correctional information) and further corrects the measurement values of the X encoder 73x and the Y encoders 73ya, 73yb. Accordingly, the encoder system 73 can measure with high accuracy the position of the fine motion stage WFS. In addition, disposing the measuring arm 71 directly below the grating RG makes it possible to greatly shorten the in-air optical path lengths of the measurement beams of the heads of the encoder system 73, which in turn reduces the effects of air turbulence and makes it possible to measure the position of the fine motion stage WFS with high accuracy.

In addition, according to the exposure apparatus 100 of the present embodiment, the main control apparatus 20 can drive, with good accuracy, the fine motion stage WFS based on the result of measuring the position of the fine motion stage WFS with good accuracy. Accordingly, the main control apparatus 20 can perform a scanning exposure that transfers, with good accuracy, the pattern of the reticle R to the wafer W by driving, with good accuracy, the wafer W, which is mounted on the fine motion stage WFS, synchronized to the reticle stage RST (i.e., the reticle R).

Furthermore, the abovementioned embodiment explained a case wherein the main control apparatus 20 corrects both for positioning errors (i.e., positional control errors; a type of Abbé error) that correspond to the tilt of the grating RG with respect to the XY plane owing to the difference ΔZ and for measurement errors owing to displacement of the grating RG (i.e., the fine motion stage WFS) in the nonmeasurement directions, particularly in the tilt (θx, θy) and rotation (θz) directions, both errors being included in the measurement values of the encoders of the encoder system 73 during an exposure. However, because the latter measurement errors are generally less than the former measurement errors, it is acceptable to correct only the former.

Furthermore, in the abovementioned embodiment, the wafer W is aligned while its position (i.e., the position of the fine motion stage WFS) is measured via the laser interferometer system (not shown), but the present invention is not limited thereto; for example, a second fine motion stage position measuring system, which includes a measuring arm that is identically configured to the measuring arm 71 of the fine motion stage position measuring system 70 discussed above, may be provided in the vicinity of the wafer alignment system ALG and used to measure the position of a fine motion stage within the XY plane during a wafer alignment.

Furthermore, the abovementioned embodiment and modified example explained an exemplary case wherein the fine motion stage WFS is supported moveably with respect to the coarse motion stages WCS and a sandwich structure that sandwiches a coil unit between a pair of magnet units is used for the first and second drive parts that drive the fine motion stage in directions corresponding to six degrees of freedom. However, the present invention is not limited thereto; for example, the first and second drive parts may have a structure that vertically sandwiches a magnet unit between a pair of coil units, or they may not have a sandwich structure. In addition, coil units may be disposed in the fine motion stage and magnet units may be disposed in the coarse motion stages.

In addition, in the abovementioned embodiment and modified example, the first and second drive parts (52) drive the fine motion stage WFS in directions corresponding to six degrees of freedom, but the fine motion stage does not necessarily have to be able to be driven in six degrees of freedom. For example, the first and second drive parts do not have to be able to drive the fine motion stage in the θx directions.

Furthermore, in the abovementioned embodiment, the coarse motion stages WCS support the fine motion stage WFS noncontactually by virtue of the action of the Lorentz's forces (i.e., electromagnetic forces), but the present invention is not limited thereto; for example, a vacuum boosted aerostatic bearing and the like may be provided to the fine motion stage WFS, and the coarse motion stages WCS may levitationally support the fine motion stage WFS. In addition, the fine motion stage drive system 52 is not limited to the moving magnet type discussed above and may be a moving coil type. Furthermore, the coarse motion stages WCS may support the fine motion stage WFS contactually. Accordingly, the fine motion stage drive system 52 that drives the fine motion stage WFS with respect to the coarse motion stages WCS may comprise a combination of, for example, a rotary motor and a ball screw (or a feed screw).

In addition, the abovementioned embodiment and modified example explain a case wherein the fine motion stage position measuring system 70 comprises the measuring arm 71, which is formed entirely from, for example, glass, wherethrough light can travel, but the present invention is not limited thereto; for example, the measuring arm may be configured such that at least the portion wherethrough the laser beams discussed above can travel is formed as a solid member capable of transmitting the light, and the remaining portion is a member that, for example, does not transmit the light; furthermore, the measuring arm may have a hollow structure.

In addition, for example, the measuring arm 71 may be configured such that the light source, the photodetector, and the like are built into the tip part of the measuring arm as long as the measurement beams can be radiated from the portion that opposes the grating. In such a case, the measurement beams of the encoder would not have to travel through the interior of the measuring arm. Furthermore, the shape of the measuring arm does not particularly matter. In addition, the fine motion stage position measuring system does not necessarily have to comprise the measuring arm and may have some other configuration as long as it comprises a head disposed such that it opposes the grating RG disposed in the spaces of the coarse motion stages, radiates at least one measurement beam to the grating RG, and receives a diffracted beam of the measurement beam from the grating RG, and as long as the position of the fine motion stage WFS can be measured at least within the XY plane based on the output of that head.

In addition, the abovementioned embodiment explained an exemplary case wherein the encoder system 73 comprises the X head and the pair of Y heads, but the present invention is not limited thereto; for example, one or two two-dimensional heads (i.e., 2D heads), whose measurement directions are in two directions, namely, the X axial directions and the Y axial directions, may be provided. If two 2D heads are provided, then their detection points may be two points that are equidistantly spaced apart from the center of the exposure position on the grating in the X axial directions.

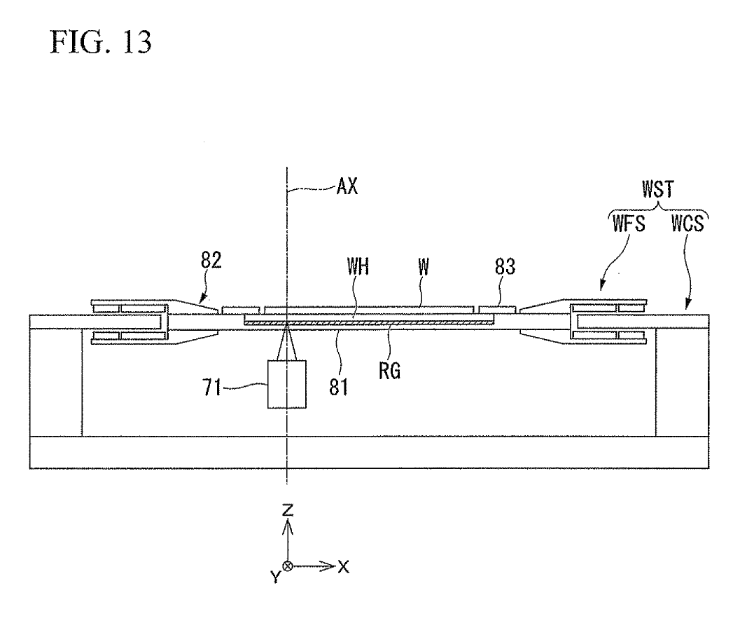

Furthermore, in the abovementioned embodiment, the grating RG is disposed on the upper surface of the fine motion stage WFS, namely, on the surface that opposes the wafer, but the present invention is not limited thereto; for example, as shown in FIG. 13, the grating RG may be formed in the lower surface of the wafer holder WH, which holds the wafer W. In such a case, even if the wafer holder WH expands during an exposure or if a mounting position deviates with respect to the fine motion stage WFS, it is possible to track this deviation and still measure the position of the wafer holder (i.e., the wafer). In addition, the grating may be disposed on the lower surface of the fine motion stage; in such a case, the measurement beams radiated from the encoder heads would not travel through the interior of the fine motion stage and, therefore, the fine motion stage would not have to be a solid member wherethrough the light can transmit, the interior of the fine motion stage could have a hollow structure wherein piping, wiring, and the like could be disposed, and the fine motion stage could be made more lightweight.

Furthermore, the abovementioned embodiment explained a case wherein the exposure apparatus 100 is a liquid immersion type exposure apparatus, but the present invention is not limited thereto; for example, the present invention can be suitably adapted also to a dry type exposure apparatus that exposes the wafer W without transiting any liquid (i.e., water).

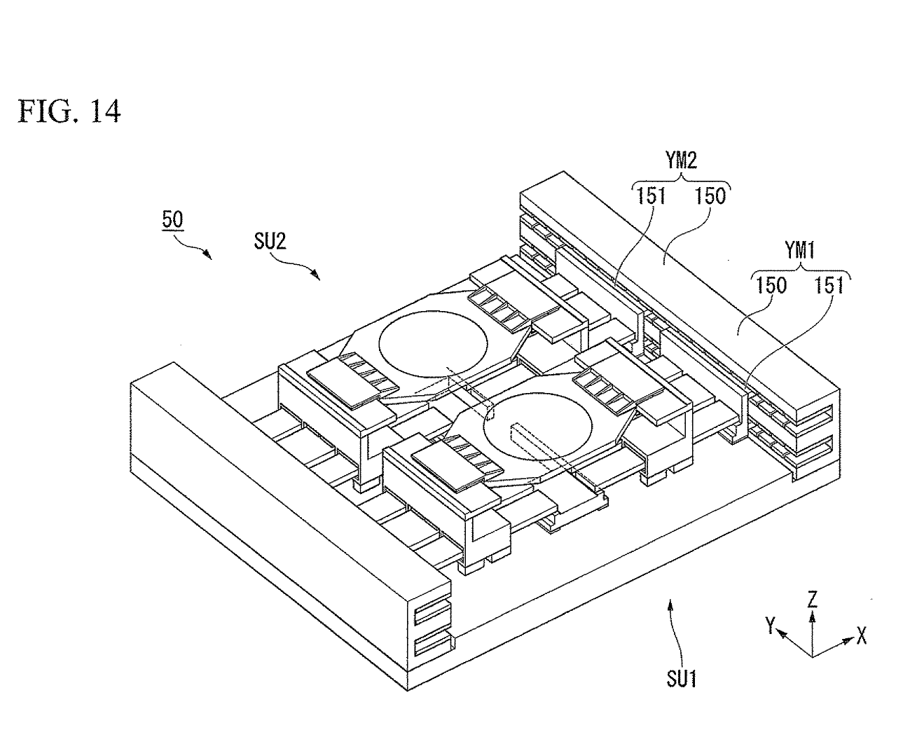

Furthermore, the abovementioned embodiment explained a single stage type exposure apparatus wherein the stage apparatus 50 comprises one stage unit SU, but the present invention is not limited thereto; for example, as shown in FIG. 14, the present invention can be suitably adapted also to a twin stage type exposure apparatus that comprises two stage units SU1, SU2. The modified example in FIG. 14 shows one embodiment of a configuration wherein two Y linear motors YM1, YM2 share one stator 150, but the present invention is not limited thereto; for example, various configurations can be adopted. In the case wherein the stage apparatus 50 is a twin stage type, two of the fine motion stage position measuring systems 70, corresponding to the two stage units SU1, SU2, may be provided at different positions within the XY plane. Adapting the present invention to a twin stage type exposure apparatus makes it possible to measure, with high accuracy, the positions of the two fine motion stages WFS, which are held by the two stage units SU1, SU2, within the XY plane and, thereby, to drive the fine motion stages WFS with high accuracy. Furthermore, the twin stage type exposure apparatus can also be a liquid immersion type as discussed above.

Furthermore, the abovementioned embodiment explained a case wherein the present invention is adapted to a scanning stepper, but the present invention is not limited thereto; for example, the present invention may also be adapted to a static type exposure apparatus, such as a stepper. Unlike the case wherein encoders measure the position of a stage whereon an object to be exposed is mounted and the position of the stage is measured using an interferometer, it is possible, even in the case of a stepper and the like, to reduce the generation of position measurement errors owing to air turbulence to virtually zero, and therefore to position the stage with high accuracy based on the measurement values of the encoder; as a result, a reticle pattern can be transferred to an object with high accuracy. In addition, the present invention can also be adapted to a step-and-stitch type reduction projection exposure apparatus that stitches shot regions together.

In addition, the projection optical system PL in the exposure apparatus 100 of the embodiment mentioned above is not limited to a reduction system and may be a unity magnification system or an enlargement system; furthermore, the projection optical system PL is not limited to a dioptric system and may be a catoptric system or a catadioptric system; in addition, the image projected thereby may be either an inverted image or an erect image.

In addition, the illumination light IL is not limited to ArF excimer laser light (with a wavelength of 193 nm), but may be ultraviolet light, such as KrF excimer laser light (with a wavelength of 248 nm), or vacuum ultraviolet light, such as F₂ laser light (with a wavelength of 157 nm). For example, as disclosed in U.S. Pat. No. 7,023,610, higher harmonics may also be used as the vacuum ultraviolet light by utilizing, for example, an erbium (or erbium-ytterbium) doped fiber amplifier to amplify single wavelength laser light in the infrared region or the visible region that is generated from a DFB semiconductor laser or a fiber laser, and then using a nonlinear optical crystal for wavelength conversion to convert the output laser light to ultraviolet light.

In addition, the illumination light IL of the exposure apparatus 100 in the abovementioned embodiment is not limited to light with a wavelength of 100 nm or greater, and, of course, light with a wavelength of less than 100 nm may be used. For example, the present invention can be adapted to an EUV exposure apparatus that uses extreme ultraviolet (EUV) light in the soft X-ray region (e.g., light in a wavelength band of 5-15 nm). In addition, the present invention can also be adapted to an exposure apparatus that uses a charged particle beam, such as an electron beam or an ion beam.

In addition, in the embodiment discussed above an optically transmissive mask (i.e., a reticle) wherein a prescribed shielding pattern (or a phase pattern or dimming pattern) is formed on an optically transmissive substrate is used; however, instead of such a reticle, an electronic mask—including variable shaped masks, active masks, and digital micromirror devices (DMDs), which are also called image generators and are one type of non-light emitting image display devices (i.e., spatial light modulators)—may be used wherein a transmissive pattern, a reflective pattern, or a light emitting pattern is formed based on electronic data of the pattern to be exposed, as disclosed in, for example, U.S. Pat. No. 6,778,257. In the case wherein a variable shaped mask is used, the stage whereon the wafer, a glass plate, or the like is mounted is scanned with respect to the variable shaped mask, and therefore effects equivalent to those of the abovementioned embodiment can be obtained by using the encoder system and a laser interferometer system to measure the position of the stage.

In addition, by forming interference fringes on the wafer W as disclosed in, for example, PCT International Publication No. WO2001/035168, the present invention can also be adapted to an exposure apparatus (i.e., a lithographic system) that forms a line-and-space pattern on the wafer W.

Furthermore, the present invention can also be adapted to, for example, an exposure apparatus that combines the patterns of two reticles onto a wafer via a projection optical system and double exposes, substantially simultaneously, a single shot region on the wafer using a single scanning exposure, as disclosed in, for example, U.S. Pat. No. 6,611,316.

Furthermore, in the abovementioned embodiment, the object whereon the pattern is to be formed (i.e., the object to be exposed by being irradiated with an energy beam) is not limited to a wafer, and may be a glass plate, a ceramic substrate, a film member, or some other object such as a mask blank.

The application of the exposure apparatus is not limited to an exposure apparatus 100 for fabricating semiconductor devices, but can be widely adapted to, for example, an exposure apparatus for fabricating liquid crystal devices, wherein a liquid crystal display device pattern is transferred to a rectangular glass plate, as well as to exposure apparatuses for fabricating organic electroluminescent displays, thin film magnetic heads, image capturing devices (e.g., CCDs), micromachines, and DNA chips. In addition to fabricating microdevices like semiconductor devices, the present invention can also be adapted to an exposure apparatus that transfers a circuit pattern to a glass substrate, a silicon wafer, or the like in order to fabricate a reticle or a mask used by a light exposure apparatus, an EUV exposure apparatus, an X-ray exposure apparatus, an electron beam exposure apparatus, and the like.

Furthermore, the moving body apparatuses of the present invention are not limited in their application to the exposure apparatus and can be widely adapted to any of the substrate processing apparatuses (e.g., a laser repair apparatus, a substrate inspecting apparatus, and the like) or to an apparatus that comprises a movable stage such as a sample positioning apparatus in a precision machine, or a wire bonding apparatus.

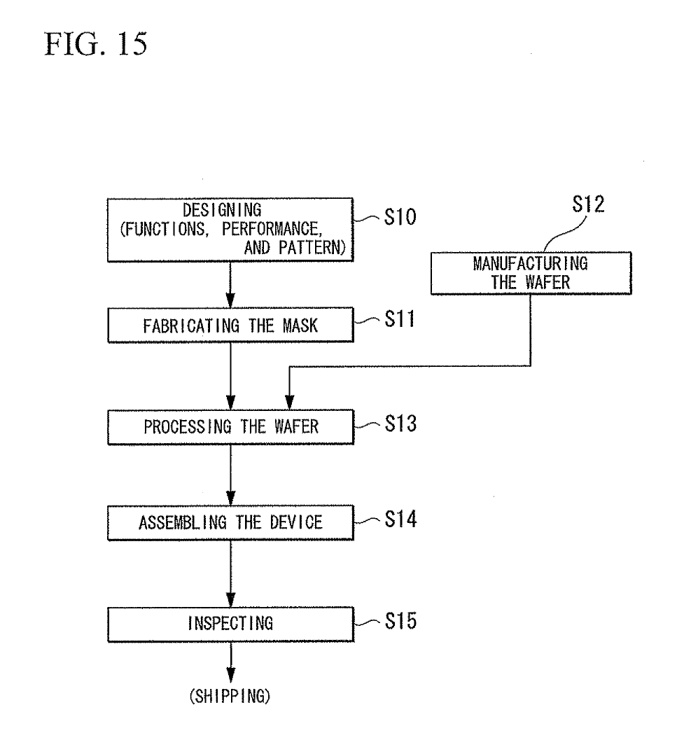

The following text explains a method of fabricating microdevices using the exposure apparatus and the exposing method according to the above-described embodiments in a lithographic process. FIG. 15 depicts a flow chart of an example of fabricating a microdevice (i.e., a semiconductor chip such as an IC or an LSI; a liquid crystal panel; a CCD; a thin film magnetic head; a micromachine; and the like).

First, in a step S10 (i.e., a designing step), the functions and performance of the microdevice (e.g., the circuit design of the semiconductor device), as well as the pattern for implementing those functions, are designed. Next, in a step S11 (i.e., a mask fabricating step), the mask (i.e., the reticle), wherein the designed circuit pattern is formed, is fabricated. Moreover, in a step S12 (i.e., a wafer manufacturing step), the wafer is manufactured using a material such as silicon.

Next, in a step S13 (i.e., a wafer processing step), the actual circuit and the like are formed on the wafer by, for example, lithographic technology (discussed later) using the mask and the wafer that were prepared in the steps S10-S12. Then, in a step S14 (i.e., a device assembling step), the device is assembled using the wafer that was processed in the step S13. In the step S14, processes are included as needed, such as the dicing, bonding, and packaging (i.e., chip encapsulating) processes. Lastly, in a step S15 (i.e., an inspecting step), inspections are performed, for example, an operation verification test and a durability test of the microdevice fabricated in the step S14. Finishing such processes completes the fabrication of the microdevice, which is then shipped.

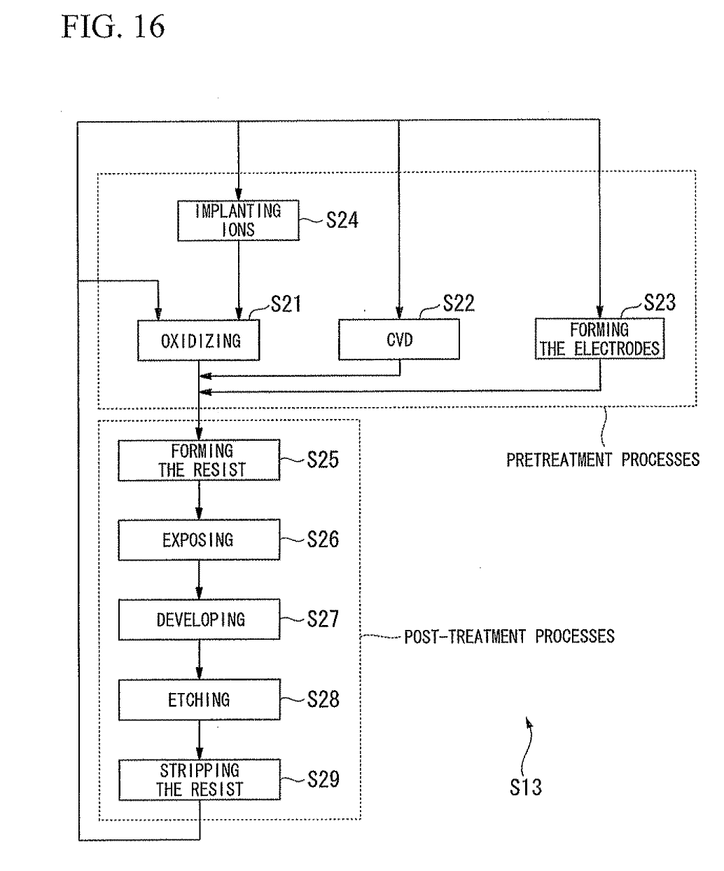

FIG. 16 depicts one example of the detailed process of the step S13 for the case of a semiconductor device.

In a step S21 (i.e., an oxidizing step), the front surface of the wafer is oxidized. In a step S22 (i.e., a CVD step), an insulating film is formed on the front surface of the wafer. In a step S23 (i.e., an electrode forming step), an electrode is formed on the wafer by vacuum deposition. In a step S24 (i.e., an ion implanting step), ions are implanted in the wafer. The above steps S21-S24 constitute the pretreatment processes of the various stages of wafer processing and are selectively performed in accordance with the processes needed in the various stages.

When the pretreatment processes discussed above in each stage of the wafer process are complete, post-treatment processes are performed as described below. In the post-treatment processes, the wafer is first coated with a photosensitive agent in a step S25 (i.e., a resist forming step). Continuing, in a step S26 (i.e., an exposing step), the circuit pattern of the mask is transferred onto the wafer by the lithography system (i.e., the exposure apparatus) and the exposing method explained above. Next, in a step S27 (i.e., a developing step), the exposed wafer is developed; further, in a step S28 (i.e., an etching step), the uncovered portions are removed by etching, excluding the portions where the resist remains. Further, in a step S29 (i.e., a resist removing step), etching is finished and the resist that is no longer needed is stripped. Circuit patterns are superposingly formed on the wafer by repetitively performing the pretreatment and post-treatment processes.

As explained above, the moving body apparatuses according to an embodiment of the present invention are suitable for driving a moving body within a prescribed plane. In addition, the exposure apparatus and the exposing method according to an embodiment of the present invention are suitable for forming a pattern on an object by radiating an energy beam thereto. In addition, the device fabricating method according to an embodiment of the present invention is suitable for fabricating electronic devices.

1. A stage apparatus, comprising:
a first moving body, which comprises a guide member that extends in a first direction, that moves in a second direction, which is substantially orthogonal to the first direction;
two second moving bodies, which are provided along the guide member such that they are independently moveable in the first direction, that move in the second direction together with the guide member by the movement of the first moving body;
a holding member, which is detachably supported by the two second moving bodies, that is capable of moving with six degrees of freedom with respect to the two second moving bodies while holding an object;
a measuring apparatus that radiates a measurement beam to a measurement surface, which is formed on a surface on the side opposite a holding surface whereon the object of the holding member is held, and measures the position of the holding member in a direction corresponding to six degrees of freedom by receiving the reflected beam of the measurement beam reflected from the measurement surface; and
a control apparatus that, based on tilt information of the positional information of the holding member, corrects information selected from the group consisting of the first direction positional information and the second direction positional information of the holding member.

2. The stage apparatus according to claim 1, wherein
the control apparatus performs correction based on the tilt information and a distance between the object surface and the measurement surface.

3. The stage apparatus according to claim 2, wherein
the control apparatus prestores information related to the distance, within an area of the holding surface, between the holding surface and the measurement surface and performs correction based on the information related to that distance.

4. The stage apparatus according to claim 1, wherein
the holding member is supported noncontactually by the two second moving bodies via an electromagnetic actuator; and
the control apparatus uses the electromagnetic actuator to correct information selected from the group consisting of the first direction positional information and the second direction positional information of the holding member.

5. The stage apparatus according to claim 1, wherein
at least part of the holding member is a solid part wherethrough light can travel;
the holding member has the measurement surface, which is disposed on the holding surface side and opposing the solid part; and
a grating, which is a two dimensional grating whose direction of periodicity is parallel to the first direction and the second direction.

6. The stage apparatus according to claim 1, wherein
the measuring apparatus comprises a measuring arm, which is positioned between the two second moving bodies; and
at least part of a head, which radiates the measurement beam to the grating and receives a diffracted beam from the grating that originates from the measurement beam, is provided to the measuring arm.

7. The stage apparatus according to claim 1, wherein
the measuring apparatus comprises a tilt measurement system, part of which is disposed in the measuring arm, that radiates at least three measurement beams to an installation surface of the grating of the moving body and receives the reflected beams of the measurement beams reflected from the holding member.

8. The stage apparatus according to claim 1, comprising:
first and second stage units, each of which comprises the first moving body and the second moving bodies;
wherein,
the first and second stage units are capable of moving independently while supporting the separate holding members.

9. An exposure apparatus that forms a pattern on an object by radiating an energy beam, comprising:
a patterning apparatus, which radiates the energy beam to the object; and
a stage apparatus according to claim 1, wherein the object irradiated by the energy beam is held by the moving body.

10. The exposure apparatus according to claim 9, wherein
the measurement beam that impinges the holding member is radiated to a prescribed point within the irradiation area of the energy beam.

11. The exposure apparatus according to claim 10, wherein
the prescribed point is an exposure center of the patterning apparatus.

12. A device fabricating method, comprising:
exposing a substrate, which serves as the object, using an exposure apparatus according to claim 9; and
developing the exposed substrate.
